(19) United States
(12) Patent Application Publication
(10) Pub. No.: US 2021/0119871 A1
(43) Pub. Date: Apr. 22, 2021

(54) PROXY CONFIGURATION FOR MULTIPLE NETWORKS

(71) Applicant: Citrix Systems, Inc., Fort Lauderdale, FL (US)

(72) Inventors: James Michael Page, Coral Springs, FL (US); Todd Giebler, Pompano Beach, FL (US)

(21) Appl. No.: 16/659,324

(22) Filed: Oct. 21, 2019

(51) Int. Cl. H04L 12/24; H04L 29/08

(52) U.S. Cl. CPC H04L 41/0846; H04L 41/0806; H04L 41/082; H04L 67/34; H04L 41/0893; H04L 67/16; H04L 67/28; H04L 41/0886

(57) ABSTRACT

Methods and systems for proxy configuration for multiple networks are described herein. A computing device may receive a configuration file of a client network and a configuration file of a host network. The computing device may also receive configuration data. The configuration files and/or the configuration data may indicate methods for accessing resources of the client network and/or the host network. The computing device may generate, based on the configuration file of the client network, the configuration file of the host network, and/or the configuration data, a merged configuration file. The computing device may cause configuration of a device with the merged configuration file for accessing the resources.

### FIELD

Aspects described herein generally relate to computer networking, remote computer access, virtualization, and hardware and software related thereto. More specifically, one or more aspects describe herein provide proxy configuration for multiple networks.

### BACKGROUND

Enterprises are increasingly adopting cloud computing services, which may provide various services (e.g., virtual desktops) to users. Applications running on virtual desktops may be redirected to corresponding client devices, so that the processing associated with the applications may be offloaded to the client devices. The virtual desktops may be hosted in a first network, and the client devices may be located in a second network. Various resources of potential interest to the redirected applications may be located in the first network, the second network, and/or other networks.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

Virtual desktops may be implemented on host devices located in a host network. The virtual desktops may be delivered to client devices located in a client network. Applications running on the virtual desktops may be redirected to the client devices, so that the processing associated with the applications may be offloaded to the client devices. Various resources of potential interest to the redirected applications running on the client devices may be located in the host network, the client network, a network accessible via a proxy server in the host network, a network accessible via a proxy server in the client network, and/or other networks.

A configuration file associated with the client network may indicate methods in which devices in the client network may access resources associated with the client network. A configuration file associated with the host network may indicate methods in which devices in the host network may access resources associated with the host network. Configuration data may be received (e.g., from an administrator) indicating various methods for accessing particular resources. As the redirected applications running on the client devices in the client network may be configured to use the configuration file associated with the client network, the redirected applications might not be able to access the resources associated with the host network and/or to access the various resources in a preferred manne.

To overcome limitations described above, and to overcome other limitations that will be apparent upon reading and understanding the present specification, aspects described herein are directed towards proxy configuration for multiple networks. A computing device may receive a plurality of configuration files. The configuration files may include a first configuration file of a client network and a second configuration file of a host network. The second configuration file may include at least one identifier configured to enable direct access to a resource of the host network. The computing device may generate a merged configuration file for a client device based on the first configuration file and second configuration file. The merged configuration file may be configured to replace the at least one identifier of the second configuration file with an identifier configured to enable the client device to access the resource of the host network via a proxy device. The computing device may configure the client device based on the merged configuration file. The configuration of the client device may enable an application executable on the client device to access resources of the client network or the host network.

In some example, the computing device may determine, based on the first configuration file of the client network, one or more first resource specific rules indicating one or more uniform resource locators (URLs) and one or more access methods corresponding to the one or more URLs. The computing device may determine, based on the first configuration file of the client network, a first default rule indicating one or more access methods corresponding to URLs other than the one or more URLs.

In some examples, the computing device may determine, based on the second configuration file of the host network, one or more second resource specific rules associated with the host network. The computing device may determine, based on the second configuration file of the host network, a second default rule, associated with the host network, of the one or more second resource specific rules.

In some examples, the merged configuration file may indicate a default access instruction based on the first default rule. The generating the merged configuration file may be based on the one or more first resource specific rules and the one or more second resource specific rules.

In some examples, the merged configuration file may indicate a default access instruction based on the second default rule. The generating the merged configuration file may be based on the one or more first resource specific rules and the one or more second resource specific rules.

In some examples, based on determining that the one or more first resource specific rules overlap with the one or more second resource specific rules, the computing device may remove, from the merged configuration file, at least one rule that that overlaps with another rule.

In some examples, the computing device may determine, based on the second configuration file of the host network, one or more proxy devices, in the host network, for accessing one or more resources of the host network. The computing device may determine one or more communication channels between the client device in the client network and the one or more proxy devices. The computing device may update the second configuration file of the host network with one or more identifiers associated with the one or more communication channels.

In some examples, the computing device may generate the merged configuration file by, based on determining that a proxy device of the one or more proxy devices corresponds to a default rule of the second configuration file of the host network, setting the merged configuration file with a default access instruction based on the default rule.

In some examples, the one or more identifiers associated with the one or more communication channels may comprise one or more port numbers of a loopback network interface of the client device.

In some examples, the computing device may configure the client device with the one or more communication channels via a host device.

In some examples, the computing device may receive configuration data that indicates that one or more URLs are accessible using the client network or the host network. The computing device may generate the merged configuration file based on the received configuration data.

In some examples, a host device in the host network may implement a virtual machine executing a first web browser. The client device in the client network may implement a second web browser, redirected from the first web browser, for executing the merged configuration file.

In some examples, the first configuration file of the client network may comprise a proxy auto-config (PAC) file of the client network. The second configuration file of the host network may comprise a PAC file of the host network.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIG. 5 depicts an illustrative enterprise mobility management system.

FIG. 6 depicts another illustrative enterprise mobility management system.

FIG. 7 is a schematic diagram showing an example system for proxy configuration for multiple networks.

FIG. 8 is a schematic diagram showing an example system for generating merged configuration files.

FIGS. 9A-9C are flowcharts showing an example method for proxy configuration for multiple networks.

FIG. 10 shows an example configuration file associated with a host network.

FIG. 11 shows an example configuration file associated with a client network.

FIG. 12 shows an example rewritten configuration file associated with a host network.

FIG. 13 shows an example exception rule for a default client fetch mode.

FIG. 14 shows example exception rules for a default host fetch mode.

FIG. 15 is a flowchart showing an example method for providing a merged configuration file.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards proxy configuration for multiple networks. Virtual desktops may be implemented on host devices located in a host network. The virtual desktops may be delivered to client devices located in a client network. Applications running on the virtual desktops may be redirected to the client devices, so that the processing associated with the applications may be offloaded to the client devices. Various resources of potential interest to the redirected applications running on the client devices may be located in the host network, the client network, a network accessible via a proxy server in the host network, a network accessible via a proxy server in the client network, and/or other networks.

A configuration file associated with the client network may indicate methods in which devices in the client network may access resources associated with the client network. A configuration file associated with the host network may indicate methods in which devices in the host network may access resources associated with the host network. Configuration data may be received (e.g., from an administrator) indicating various methods for accessing particular resources. As the redirected applications running on the client devices in the client network may be configured to use the configuration file associated with the client network, the redirected applications might not be able to access the resources associated with the host network and/or to access the various resources in a preferred manne.

Generating a merged configuration file for use by applications running on the client devices may help alleviate these challenges. The merged configuration file may be generated based on the configuration file associated with the host network, the configuration file associated with the client network, and/or the configuration data. The merged configuration file may be generated, for example, by a configuration file generating device, a host device, a client device, and/or any other computing device. Communication channels dedicated to transmitting traffic associated with accessing the various resources may be established between the client devices and the host devices. The rules in the merged configuration file may be based on the communication channels, and may indicate updated access methods using the communication channels to access resources associated with the host network. The rules in the merged configuration file may also indicate the preferred method(s) for accessing a particular resource.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect mounting, connecting, coupling, positioning and engaging.

Computing Architecture

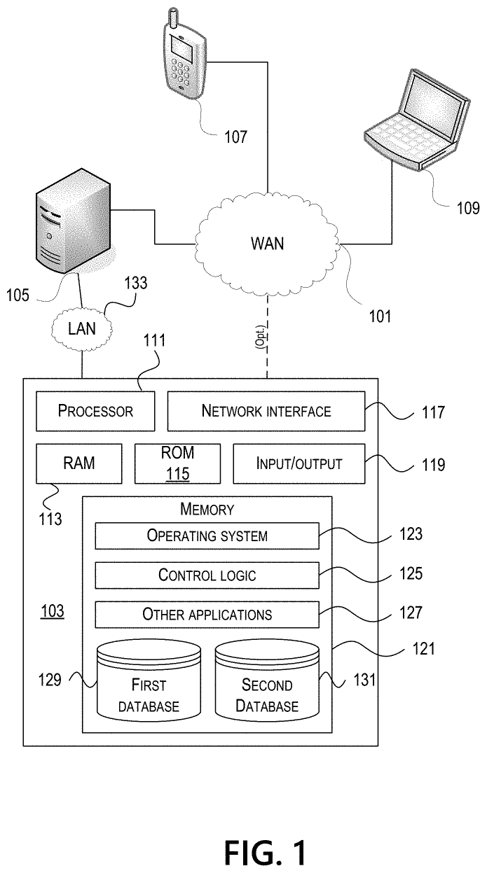

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

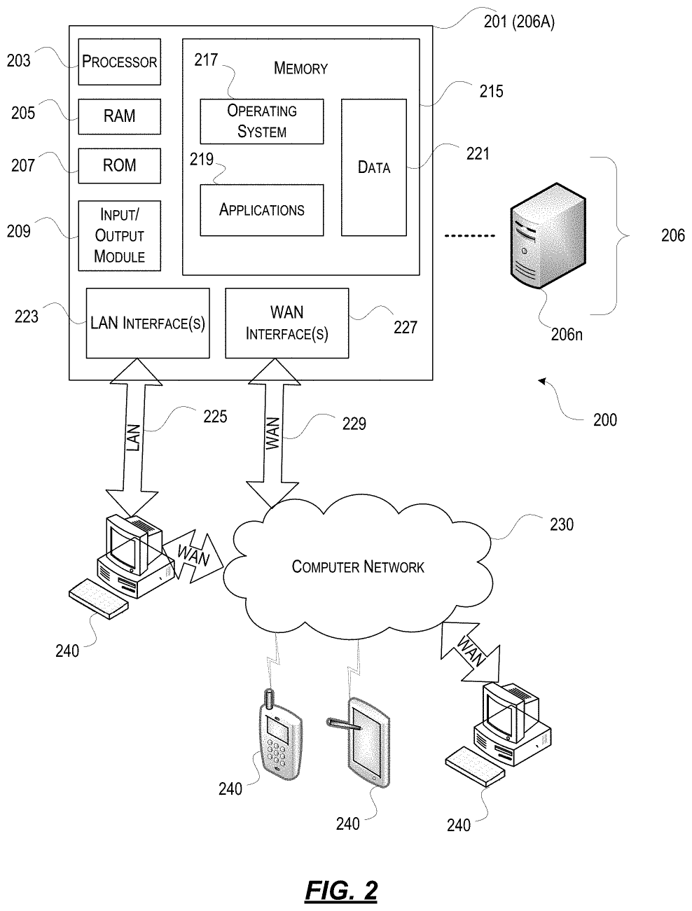

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

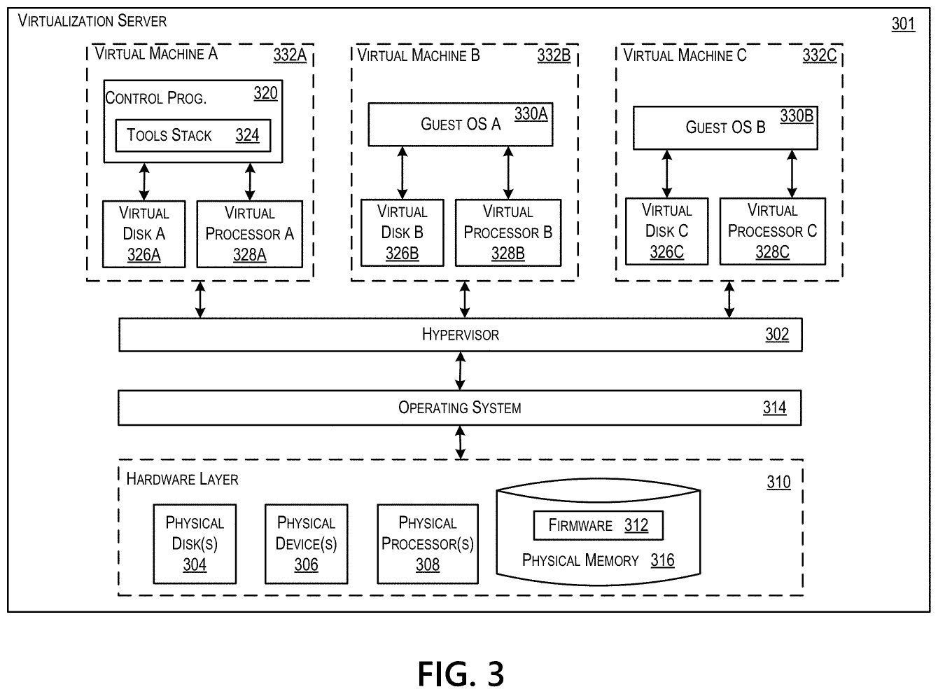

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be a Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, Calif.; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

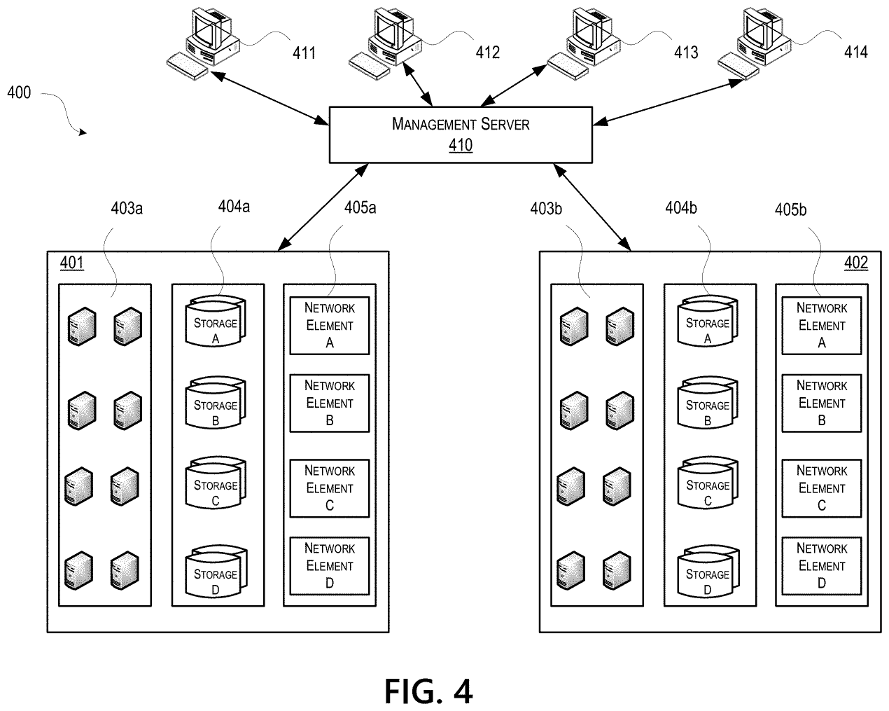

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, Fla., or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Wash.), AMAZON EC2 (Amazon.com Inc. of Seattle, Wash.), IBM BLUE CLOUD (IBM Corporation of Armonk, N.Y.), or others.

Enterprise Mobility Management Architecture

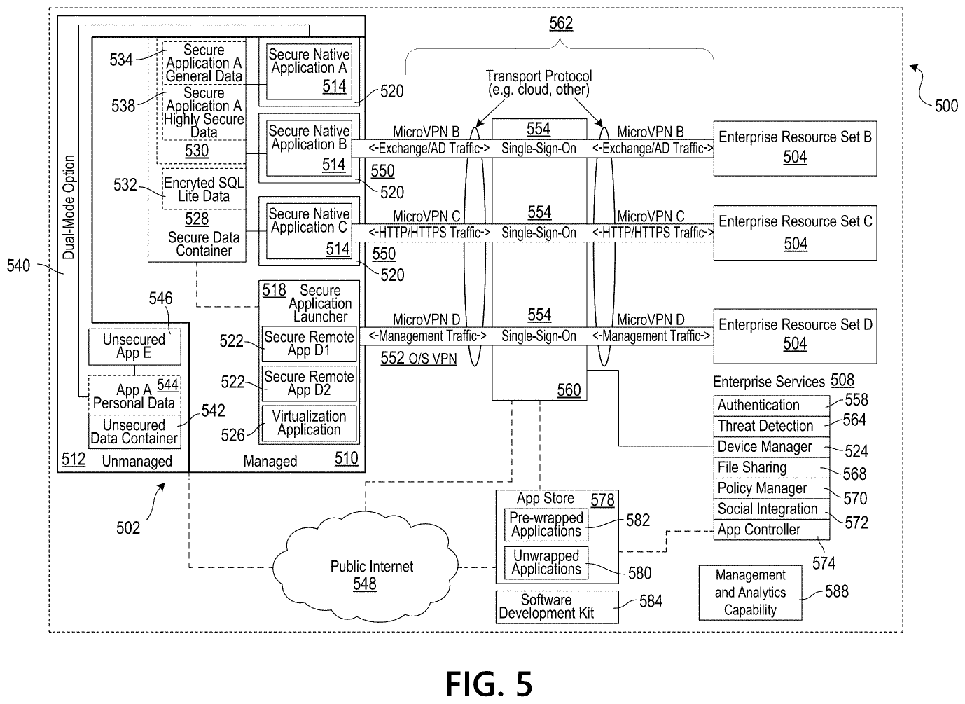

FIG. 5 represents an enterprise mobility technical architecture 500 for use in a “Bring Your Own Device” (BYOD) environment. The architecture enables a user of a mobile device 502 to both access enterprise or personal resources from a mobile device 502 and use the mobile device 502 for personal use. The user may access such enterprise resources 504 or enterprise services 508 using a mobile device 502 that is purchased by the user or a mobile device 502 that is provided by the enterprise to the user. The user may utilize the mobile device 502 for business use only or for business and personal use. The mobile device 502 may run an iOS operating system, an Android operating system, or the like. The enterprise may choose to implement policies to manage the mobile device 502. The policies may be implemented through a firewall or gateway in such a way that the mobile device 502 may be identified, secured or security verified, and provided selective or full access to the enterprise resources (e.g., 504 and 508.) The policies may be mobile device management policies, mobile application management policies, mobile data management policies, or some combination of mobile device, application, and data management policies. A mobile device 502 that is managed through the application of mobile device management policies may be referred to as an enrolled device.

In some embodiments, the operating system of the mobile device 502 may be separated into a managed partition 510 and an unmanaged partition 512. The managed partition 510 may have policies applied to it to secure the applications running on and data stored in the managed partition 510. The applications running on the managed partition 510 may be secure applications. In other embodiments, all applications may execute in accordance with a set of one or more policy files received separate from the application, and which define one or more security parameters, features, resource restrictions, and/or other access controls that are enforced by the mobile device management system when that application is executing on the mobile device 502. By operating in accordance with their respective policy file(s), each application may be allowed or restricted from communications with one or more other applications and/or resources, thereby creating a virtual partition. Thus, as used herein, a partition may refer to a physically partitioned portion of memory (physical partition), a logically partitioned portion of memory (logical partition), and/or a virtual partition created as a result of enforcement of one or more policies and/or policy files across multiple applications as described herein (virtual partition). Stated differently, by enforcing policies on managed applications, those applications may be restricted to only be able to communicate with other managed applications and trusted enterprise resources, thereby creating a virtual partition that is not accessible by unmanaged applications and devices.

The secure applications may be email applications, web browsing applications, software-as-a-service (SaaS) access applications, Windows Application access applications, and the like. The secure applications may be secure native applications 514, secure remote applications 522 executed by a secure application launcher 518, virtualization applications 526 executed by a secure application launcher 518, and the like. The secure native applications 514 may be wrapped by a secure application wrapper 520. The secure application wrapper 520 may include integrated policies that are executed on the mobile device 502 when the secure native application 514 is executed on the mobile device 502. The secure application wrapper 520 may include meta-data that points the secure native application 514 running on the mobile device 502 to the resources hosted at the enterprise (e.g., 504 and 508) that the secure native application 514 may require to complete the task requested upon execution of the secure native application 514. The secure remote applications 522 executed by a secure application launcher 518 may be executed within the secure application launcher 518. The virtualization applications 526 executed by a secure application launcher 518 may utilize resources on the mobile device 502, at the enterprise resources 504, and the like. The resources used on the mobile device 502 by the virtualization applications 526 executed by a secure application launcher 518 may include user interaction resources, processing resources, and the like. The user interaction resources may be used to collect and transmit keyboard input, mouse input, camera input, tactile input, audio input, visual input, gesture input, and the like. The processing resources may be used to present a user interface, process data received from the enterprise resources 504, and the like. The resources used at the enterprise resources 504 by the virtualization applications 526 executed by a secure application launcher 518 may include user interface generation resources, processing resources, and the like. The user interface generation resources may be used to assemble a user interface, modify a user interface, refresh a user interface, and the like. The processing resources may be used to create information, read information, update information, delete information, and the like. For example, the virtualization application 526 may record user interactions associated with a graphical user interface (GUI) and communicate them to a server application where the server application will use the user interaction data as an input to the application operating on the server. In such an arrangement, an enterprise may elect to maintain the application on the server side as well as data, files, etc. associated with the application. While an enterprise may elect to “mobilize” some applications in accordance with the principles herein by securing them for deployment on the mobile device 502, this arrangement may also be elected for certain applications. For example, while some applications may be secured for use on the mobile device 502, others might not be prepared or appropriate for deployment on the mobile device 502 so the enterprise may elect to provide the mobile user access to the unprepared applications through virtualization techniques. As another example, the enterprise may have large complex applications with large and complex data sets (e.g., material resource planning applications) where it would be very difficult, or otherwise undesirable, to customize the application for the mobile device 502 so the enterprise may elect to provide access to the application through virtualization techniques. As yet another example, the enterprise may have an application that maintains highly secured data (e.g., human resources data, customer data, engineering data) that may be deemed by the enterprise as too sensitive for even the secured mobile environment so the enterprise may elect to use virtualization techniques to permit mobile access to such applications and data. An enterprise may elect to provide both fully secured and fully functional applications on the mobile device 502 as well as a virtualization application 526 to allow access to applications that are deemed more properly operated on the server side. In an embodiment, the virtualization application 526 may store some data, files, etc. on the mobile device 502 in one of the secure storage locations. An enterprise, for example, may elect to allow certain information to be stored on the mobile device 502 while not permitting other information.

In connection with the virtualization application 526, as described herein, the mobile device 502 may have a virtualization application 526 that is designed to present GUIs and then record user interactions with the GUI. The virtualization application 526 may communicate the user interactions to the server side to be used by the server side application as user interactions with the application. In response, the application on the server side may transmit back to the mobile device 502 a new GUI. For example, the new GUI may be a static page, a dynamic page, an animation, or the like, thereby providing access to remotely located resources.

The secure applications 514 may access data stored in a secure data container 528 in the managed partition 510 of the mobile device 502. The data secured in the secure data container may be accessed by the secure native applications 514, secure remote applications 522 executed by a secure application launcher 518, virtualization applications 526 executed by a secure application launcher 518, and the like. The data stored in the secure data container 528 may include files, databases, and the like. The data stored in the secure data container 528 may include data restricted to a specific secure application 530, shared among secure applications 532, and the like. Data restricted to a secure application may include secure general data 534 and highly secure data 538. Secure general data may use a strong form of encryption such as Advanced Encryption Standard (AES) 128-bit encryption or the like, while highly secure data 538 may use a very strong form of encryption such as AES 256-bit encryption. Data stored in the secure data container 528 may be deleted from the mobile device 502 upon receipt of a command from the device manager 524. The secure applications (e.g., 514, 522, and 526) may have a dual-mode option 540. The dual mode option 540 may present the user with an option to operate the secured application in an unsecured or unmanaged mode. In an unsecured or unmanaged mode, the secure applications may access data stored in an unsecured data container 542 on the unmanaged partition 512 of the mobile device 502. The data stored in an unsecured data container may be personal data 544. The data stored in an unsecured data container 542 may also be accessed by unsecured applications 546 that are running on the unmanaged partition 512 of the mobile device 502. The data stored in an unsecured data container 542 may remain on the mobile device 502 when the data stored in the secure data container 528 is deleted from the mobile device 502. An enterprise may want to delete from the mobile device 502 selected or all data, files, and/or applications owned, licensed or controlled by the enterprise (enterprise data) while leaving or otherwise preserving personal data, files, and/or applications owned, licensed or controlled by the user (personal data). This operation may be referred to as a selective wipe. With the enterprise and personal data arranged in accordance to the aspects described herein, an enterprise may perform a selective wipe.

The mobile device 502 may connect to enterprise resources 504 and enterprise services 508 at an enterprise, to the public Internet 548, and the like. The mobile device 502 may connect to enterprise resources 504 and enterprise services 508 through virtual private network connections. The virtual private network connections, also referred to as microVPN or application-specific VPN, may be specific to particular applications (as illustrated by microVPNs 550, particular devices, particular secured areas on the mobile device (as illustrated by O/S VPN 552), and the like. For example, each of the wrapped applications in the secured area of the mobile device 502 may access enterprise resources through an application specific VPN such that access to the VPN would be granted based on attributes associated with the application, possibly in conjunction with user or device attribute information. The virtual private network connections may carry Microsoft Exchange traffic, Microsoft Active Directory traffic, HyperText Transfer Protocol (HTTP) traffic, HyperText Transfer Protocol Secure (HTTPS) traffic, application management traffic, and the like. The virtual private network connections may support and enable single-sign-on authentication processes 554. The single-sign-on processes may allow a user to provide a single set of authentication credentials, which are then verified by an authentication service 558. The authentication service 558 may then grant to the user access to multiple enterprise resources 504, without requiring the user to provide authentication credentials to each individual enterprise resource 504.

The virtual private network connections may be established and managed by an access gateway 560. The access gateway 560 may include performance enhancement features that manage, accelerate, and improve the delivery of enterprise resources 504 to the mobile device 502. The access gateway 560 may also re-route traffic from the mobile device 502 to the public Internet 548, enabling the mobile device 502 to access publicly available and unsecured applications that run on the public Internet 548. The mobile device 502 may connect to the access gateway via a transport network 562. The transport network 562 may use one or more transport protocols and may be a wired network, wireless network, cloud network, local area network, metropolitan area network, wide area network, public network, private network, and the like.

The enterprise resources 504 may include email servers, file sharing servers, SaaS applications, Web application servers, Windows application servers, and the like. Email servers may include Exchange servers, Lotus Notes servers, and the like. File sharing servers may include ShareFile servers, and the like. SaaS applications may include Salesforce, and the like. Windows application servers may include any application server that is built to provide applications that are intended to run on a local Windows operating system, and the like. The enterprise resources 504 may be premise-based resources, cloud-based resources, and the like. The enterprise resources 504 may be accessed by the mobile device 502 directly or through the access gateway 560. The enterprise resources 504 may be accessed by the mobile device 502 via the transport network 562.

The enterprise services 508 may include authentication services 558, threat detection services 564, device manager services 524, file sharing services 568, policy manager services 570, social integration services 572, application controller services 574, and the like. Authentication services 558 may include user authentication services, device authentication services, application authentication services, data authentication services, and the like. Authentication services 558 may use certificates. The certificates may be stored on the mobile device 502, by the enterprise resources 504, and the like. The certificates stored on the mobile device 502 may be stored in an encrypted location on the mobile device 502, the certificate may be temporarily stored on the mobile device 502 for use at the time of authentication, and the like. Threat detection services 564 may include intrusion detection services, unauthorized access attempt detection services, and the like. Unauthorized access attempt detection services may include unauthorized attempts to access devices, applications, data, and the like. Device management services 524 may include configuration, provisioning, security, support, monitoring, reporting, and decommissioning services. File sharing services 568 may include file management services, file storage services, file collaboration services, and the like. Policy manager services 570 may include device policy manager services, application policy manager services, data policy manager services, and the like. Social integration services 572 may include contact integration services, collaboration services, integration with social networks such as Facebook, Twitter, and LinkedIn, and the like. Application controller services 574 may include management services, provisioning services, deployment services, assignment services, revocation services, wrapping services, and the like.

The enterprise mobility technical architecture 500 may include an application store 578. The application store 578 may include unwrapped applications 580, pre-wrapped applications 582, and the like. Applications may be populated in the application store 578 from the application controller 574. The application store 578 may be accessed by the mobile device 502 through the access gateway 560, through the public Internet 548, or the like. The application store 578 may be provided with an intuitive and easy to use user interface.

A software development kit 584 may provide a user the capability to secure applications selected by the user by wrapping the application as described previously in this description. An application that has been wrapped using the software development kit 584 may then be made available to the mobile device 502 by populating it in the application store 578 using the application controller 574.

The enterprise mobility technical architecture 500 may include a management and analytics capability 588. The management and analytics capability 588 may provide information related to how resources are used, how often resources are used, and the like. Resources may include devices, applications, data, and the like. How resources are used may include which devices download which applications, which applications access which data, and the like. How often resources are used may include how often an application has been downloaded, how many times a specific set of data has been accessed by an application, and the like.

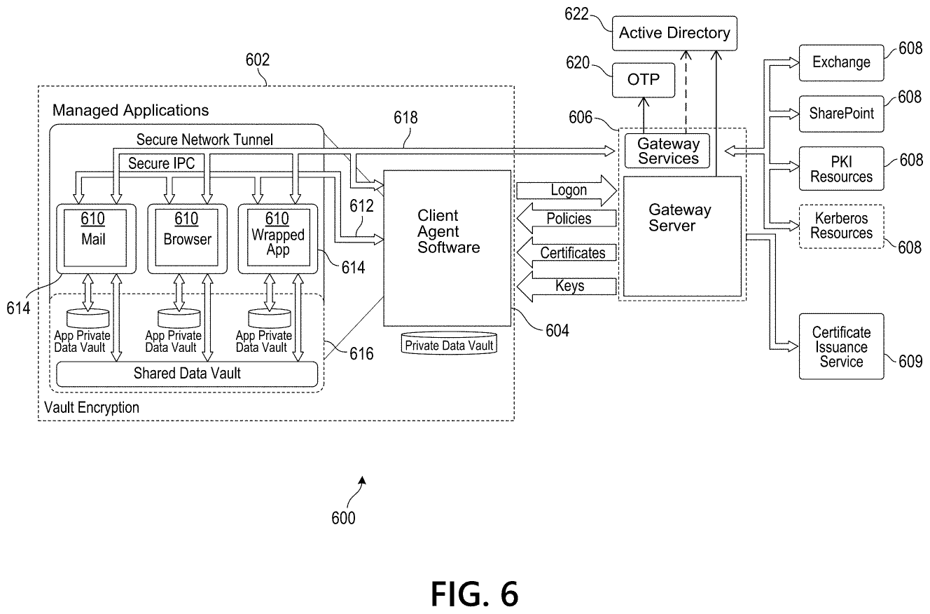

FIG. 6 is another illustrative enterprise mobility management system 600. Some of the components of the mobility management system 500 described above with reference to FIG. 5 have been omitted for the sake of simplicity. The architecture of the system 600 depicted in FIG. 6 is similar in many respects to the architecture of the system 500 described above with reference to FIG. 5 and may include additional features not mentioned above.

In this case, the left hand side represents an enrolled mobile device 602 with a client agent 604, which interacts with gateway server 606 (which includes Access Gateway and application controller functionality) to access various enterprise resources 608 and services 609 such as Exchange, Sharepoint, public-key infrastructure (PKI) Resources, Kerberos Resources, Certificate Issuance service, as shown on the right hand side above. Although not specifically shown, the mobile device 602 may also interact with an enterprise application store (StoreFront) for the selection and downloading of applications.

The client agent 604 acts as the UI (user interface) intermediary for Windows apps/desktops hosted in an Enterprise data center, which are accessed using the High-Definition User Experience (HDX)/ICA display remoting protocol. The client agent 604 also supports the installation and management of native applications on the mobile device 602, such as native iOS or Android applications. For example, the managed applications 610 (mail, browser, wrapped application) shown in the figure above are all native applications that execute locally on the mobile device 602. Client agent 604 and application management framework of this architecture act to provide policy driven management capabilities and features such as connectivity and SSO (single sign on) to enterprise resources/services 608. The client agent 604 handles primary user authentication to the enterprise, normally to Access Gateway (AG) 606 with SSO to other gateway server components. The client agent 604 obtains policies from gateway server 606 to control the behavior of the managed applications 610 on the mobile device 602.

The Secure InterProcess Communication (IPC) links 612 between the native applications 610 and client agent 604 represent a management channel, which may allow a client agent to supply policies to be enforced by the application management framework 614 “wrapping” each application. The IPC channel 612 may also allow client agent 604 to supply credential and authentication information that enables connectivity and SSO to enterprise resources 608. Finally, the IPC channel 612 may allow the application management framework 614 to invoke user interface functions implemented by client agent 604, such as online and offline authentication.

Communications between the client agent 604 and gateway server 606 are essentially an extension of the management channel from the application management framework 614 wrapping each native managed application 610. The application management framework 614 may request policy information from client agent 604, which in turn may request it from gateway server 606. The application management framework 614 may request authentication, and client agent 604 may log into the gateway services part of gateway server 606 (for example, Citrix Gateway). Client agent 604 may also call supporting services on gateway server 606, which may produce input material to derive encryption keys for the local data vaults 616, or may provide client certificates which may enable direct authentication to PKI protected resources, as more fully explained below.

In more detail, the application management framework 614 “wraps” each managed application 610. This may be incorporated via an explicit build step, or via a post-build processing step. The application management framework 614 may “pair” with client agent 604 on first launch of an application 610 to initialize the Secure IPC channel 612 and obtain the policy for that application. The application management framework 614 may enforce relevant portions of the policy that apply locally, such as the client agent login dependencies and some of the containment policies that restrict how local OS services may be used, or how they may interact with the managed application 610.

The application management framework 614 may use services provided by client agent 604 over the Secure IPC channel 612 to facilitate authentication and internal network access. Key management for the private and shared data vaults 616 (containers) may be also managed by appropriate interactions between the managed applications 610 and client agent 604. Vaults 616 may be available only after online authentication, or may be made available after offline authentication if allowed by policy. First use of vaults 616 may require online authentication, and offline access may be limited to at most the policy refresh period before online authentication is again required.

Network access to internal resources may occur directly from individual managed applications 610 through Access Gateway 606. The application management framework 614 may be responsible for orchestrating the network access on behalf of each managed application 610. Client agent 604 may facilitate these network connections by providing suitable time limited secondary credentials obtained following online authentication. Multiple modes of network connection may be used, such as reverse web proxy connections and end-to-end VPN-style tunnels 618.

The Mail and Browser managed applications 610 have special status and may make use of facilities that might not be generally available to arbitrary wrapped applications. For example, the Mail application 610 may use a special background network access mechanism that allows it to access an Exchange server 608 over an extended period of time without requiring a full AG logon. The Browser application 610 may use multiple private data vaults 616 to segregate different kinds of data.

This architecture may support the incorporation of various other security features. For example, gateway server 606 (including its gateway services) in some cases may not need to validate active directory (AD) passwords. It can be left to the discretion of an enterprise whether an AD password may be used as an authentication factor for some users in some situations. Different authentication methods may be used if a user is online or offline (i.e., connected or not connected to a network).

Step up authentication is a feature wherein gateway server 606 may identify managed native applications 610 that are allowed to have access to highly classified data requiring strong authentication, and ensure that access to these applications is only permitted after performing appropriate authentication, even if this means a re-authentication is required by the user after a prior weaker level of login.

Another security feature of this solution is the encryption of the data vaults 616 (containers) on the mobile device 602. The vaults 616 may be encrypted so that all on-device data including files, databases, and configurations are protected. For on-line vaults, the keys may be stored on the server (gateway server 606), and for off-line vaults, a local copy of the keys may be protected by a user password or biometric validation. If or when data is stored locally on the mobile device 602 in the secure container 616, it may be preferred that a minimum of AES 256 encryption algorithm be utilized.

Other secure container features may also be implemented. For example, a logging feature may be included, wherein security events happening inside a managed application 610 may be logged and reported to the backend. Data wiping may be supported, such as if or when the managed application 610 detects tampering, associated encryption keys may be written over with random data, leaving no hint on the file system that user data was destroyed. Screenshot protection may be another feature, where an application may prevent any data from being stored in screenshots. For example, the key window's hidden property may be set to YES. This may cause whatever content is currently displayed on the screen to be hidden, resulting in a blank screenshot where any content would normally reside.

Local data transfer may be prevented, such as by preventing any data from being locally transferred outside the application container, e.g., by copying it or sending it to an external application. A keyboard cache feature may operate to disable the autocorrect functionality for sensitive text fields. SSL certificate validation may be operable so the application specifically validates the server SSL certificate instead of it being stored in the keychain. An encryption key generation feature may be used such that the key used to encrypt data on the mobile device 602 is generated using a passphrase or biometric data supplied by the user (if offline access is required). It may be XORed with another key randomly generated and stored on the server side if offline access is not required. Key derivation functions may operate such that keys generated from the user password use KDFs (key derivation functions, notably Password-Based Key Derivation Function 2 (PBKDF2)) rather than creating a cryptographic hash of it. The latter makes a key susceptible to brute force or dictionary attacks.

Further, one or more initialization vectors may be used in encryption methods. An initialization vector will cause multiple copies of the same encrypted data to yield different cipher text output, preventing both replay and cryptanalytic attacks. This will also prevent an attacker from decrypting any data even with a stolen encryption key. Further, authentication then decryption may be used, wherein application data is decrypted only after the user has authenticated within the application. Another feature may relate to sensitive data in memory, which may be kept in memory (and not in disk) only when it's needed. For example, login credentials may be wiped from memory after login, and encryption keys and other data inside Objective-C instance variables are not stored, as they may be easily referenced. Instead, memory may be manually allocated for these.

An inactivity timeout may be implemented, wherein after a policy-defined period of inactivity, a user session is terminated.

Data leakage from the application management framework 614 may be prevented in other ways. For example, if or when a managed application 610 is put in the background, the memory may be cleared after a predetermined (configurable) time period. When backgrounded, a snapshot may be taken of the last displayed screen of the application to accelerate the foregrounding process. The screenshot may contain confidential data and hence should be cleared.

Another security feature may relate to the use of an OTP (one-time password) 620 without the use of an AD (Active Directory) 622 password for access to one or more applications. In some cases, some users do not know (or are not permitted to know) their AD password, so these users may authenticate using an OTP 620 such as by using a hardware OTP system like SecurID (OTPs may be provided by different vendors also, such as Entrust or Gemalto). In some cases, after a user authenticates with a user ID, a text may be sent to the user with an OTP 620. In some cases, this may be implemented only for online use, with a prompt being a single field.

An offline password may be implemented for offline authentication for those managed applications 610 for which offline use is permitted via enterprise policy. For example, an enterprise may want StoreFront to be accessed in this manner In this case, the client agent 604 may require the user to set a custom offline password and the AD password is not used. Gateway server 606 may provide policies to control and enforce password standards with respect to the minimum length, character class composition, and age of passwords, such as described by the standard Windows Server password complexity requirements, although these requirements may be modified.

Another feature may relate to the enablement of a client side certificate for certain applications 610 as secondary credentials (for the purpose of accessing PM protected web resources via the application management framework micro VPN feature). For example, a managed application 610 may utilize such a certificate. In this case, certificate-based authentication using ActiveSync protocol may be supported, wherein a certificate from the client agent 604 may be retrieved by gateway server 606 and used in a keychain. Each managed application 610 may have one associated client certificate, identified by a label that is defined in gateway server 606.

Gateway server 606 may interact with an enterprise special purpose web service to support the issuance of client certificates to allow relevant managed applications to authenticate to internal PKI protected resources.

The client agent 604 and the application management framework 614 may be enhanced to support obtaining and using client certificates for authentication to internal PKI-protected network resources. More than one certificate may be supported, such as to match various levels of security and/or separation requirements. The certificates may be used by the Mail and Browser managed applications 610, and ultimately by arbitrary wrapped applications 610 (provided those applications use web service style communication patterns where it is reasonable for the application management framework to mediate HTTPS requests).

Application management client certificate support on iOS may rely on importing a public-key cryptography standards (PKCS) 12 BLOB (Binary Large Object) into the iOS keychain in each managed application 610 for each period of use. Application management framework client certificate support may use a HTTPS implementation with private in-memory key storage. The client certificate may not be present in the iOS keychain and may not be persisted except potentially in an “online-only” data value that is strongly protected.

Mutual SSL or TLS may also be implemented to provide additional security by requiring that a mobile device 602 is authenticated to the enterprise, and vice versa. Virtual smart cards for authentication to gateway server 606 may also be implemented.

Another feature may relate to application container locking and wiping, which may automatically occur upon jail-break or rooting detections, and occur as a pushed command from administration console, and may include a remote wipe functionality even when a managed application 610 is not runnin.

A multi-site architecture or configuration of enterprise application store and an application controller may be supported that allows users to be serviced from one of several different locations in case of failure.

In some cases, managed applications 610 may be allowed to access a certificate and private key via an API (for example, OpenSSL). Trusted managed applications 610 of an enterprise may be allowed to perform specific Public Key operations with an application's client certificate and private key. Various use cases may be identified and treated accordingly, such as if or when an application behaves like a browser and no certificate access is required, if or when an application reads a certificate for “who am I,” if or when an application uses the certificate to build a secure session token, and if or when an application uses private keys for digital signing of important data (e.g. transaction log) or for temporary data encryption.

Proxy Configuration for Multiple Networks

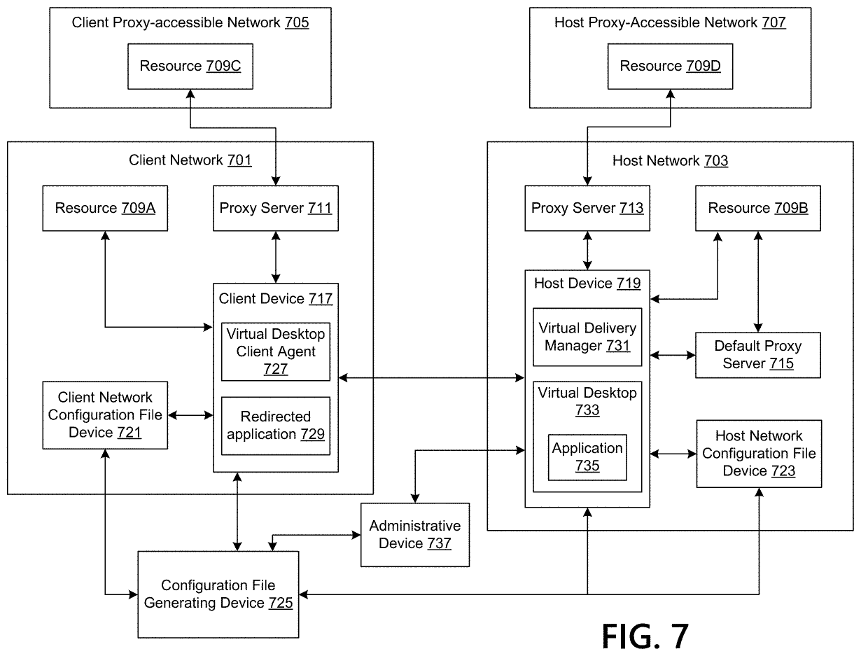

FIG. 7 is a schematic diagram showing an example system for proxy configuration for multiple networks. The system comprises one or more client networks (e.g., client network 701), one or more host networks (e.g., host network 703), one or more client proxy-accessible networks (e.g., client proxy-accessible network 705), one or more host proxy-accessible networks (e.g., host proxy-accessible network 707), one or more administrative devices (e.g., administrative device 737), and one or more configuration file generating devices (e.g., configuration file generating device 725).

Each of the client network 701, the host network 703, the client proxy-accessible network 705, and the host proxy-accessible network 707 may comprise one or more of any of various types of information distribution networks, such as, without limitation, a satellite network, a telephone network, a cellular network, a Wi-Fi network, an Ethernet network, an optical fiber network, a coaxial cable network, a hybrid fiber coax network, and/or the like. Each of the client network 701, the host network 703, the client proxy-accessible network 705, and the host proxy-accessible network 707 may comprise an Internet Protocol (IP) based network (e.g., the Internet) or other types of networks. Each of the client network 701, the host network 703, the client proxy-accessible network 705, and the host proxy-accessible network 707 may comprise, for example, the wide area network 101, the local area network 133, or the computer network 230.

One or more resources (e.g., the resources 709A-709D) may be located in the client network 701, the host network 703, the client proxy-accessible network 705, and the host proxy-accessible network 707. For example, the client network 701 may comprise the resource 709A, the host network 703 may comprise the resource 709B, the client proxy-accessible network 705 may comprise the resource 709C, and the host proxy-accessible network 707 may comprise the resource 709D. Resources 709A-709D may comprise, for example, any type of computing device configured to provide data, content, services, and/or the like. In some examples, the resources 709A-709D may comprise a web server (e.g., configured to process incoming requests over the Hypertext Transfer Protocol (HTTP) and/or other protocols), a mail server, a video server, a media server, a cloud server, an application server, a database server, a file server, a game server, and/or the like.

The client network 701, the host network 703, the client proxy-accessible network 705, and the host proxy-accessible network 707 may comprise, for example, a private network or a network configured to block unauthorized access from outside of the network. For example, the resource 709A located in the client network 701 may be directly accessed by a computing device similarly located in the client network 701. The resource 709B located in the host network 703 may be directly accessed by a computing device similarly located in the host network 703. The resource 709C located in the client proxy-accessible network 705 may be accessed by a computing device located in the client network 701 only via a proxy server located in the client network 701, such as the proxy server 711. The resource 709D located in the host proxy-accessible network 707 may be accessed by a computing device located in the host network 703 only via a proxy server located in the host network 703, such as the proxy server 713.

A proxy server of the proxy servers 711, 713 may comprise, for example, a computing device configured to act as an intermediary for requests from other computing devices to access resources. The proxy server 711 may be configured to, for example, receive a request for data stored on the resource 709C, authenticate the request, retrieve the requested data from the resource 709C, and/or send the data to the requesting device. The proxy server 713 may be configured to, for example, receive a request for data stored on the resource 709D, authenticate the request, retrieve the requested data from the resource 709D, and/or send the data to the requesting device.

The host network 703 may comprise one or more host devices (e.g., host device 719). The host device 719 may comprise, for example, a physical computing device (e.g., the data server 103, the web server 105, the server 206, etc.). Additionally or alternatively, the host device 719 may comprise a virtual machine. For example, the host device 719 may comprise one of the virtual machines 332A-332C implemented on the virtualization server 301. The host device 719 may be configured to host virtual desktops, virtual applications, web applications, and/or the like, and to provide the virtual desktops and/or the virtual applications to users. For example, the host device 719 may implement, based on desktop virtualization software, one or more virtual desktops (e.g., virtual desktop 733) and one or more virtual delivery managers (e.g., virtual delivery manager 731). The virtual delivery manager 731 may be configured to control and/or manage the virtual desktop 733, and to deliver the virtual desktop 733 to a client device, such as the client device 717. With desktop virtualization, execution and/or processing of the virtual desktop 733 may take place on the host device 719, and the display of the virtual desktop 733 may be delivered by the virtual delivery manager 731 to the client device 717.

The administrative device 737 may comprise, for example, a computing device configured to communicate with virtual delivery managers (e.g., the virtual delivery manager 731) and/or virtual desktops (e.g., the virtual desktop 733). The administrative device 737 may control and/or manage the virtual delivery managers and/or virtual desktops. For example, the administrative device 737 may set various policies, registries, and/or configurations for the virtual delivery managers and/or virtual desktops.

The client network 701 may comprise one or more client devices (e.g., client device 717). The client device 717 may comprise, for example, a user device, a smartphone, a personal computer, a tablet, a desktop computer, a laptop computer, a gaming device, a virtual reality headset, or any other computing device. Additionally, the client device 717 may comprise, for example, the computers 107, 109, the terminals 240, the client computers 411-414, the mobile device 502, or the mobile device 602 as discussed above in connection with FIGS. 1-2 and 4-6.

The client device 717 may implement one or more virtual desktop client agents (e.g., virtual desktop client agent 727). The virtual desktop client agent 727 may be configured to receive the display of the virtual desktop 733 from the virtual delivery manager 731, and to present the received display on a screen of the client device 717 to a user. Additionally, the virtual desktop client agent 727 may be configured to communicate with the virtual delivery manager 731 various types of data, such as keyboard input information, mouse input information, and/or the like.

The client device 717 (e.g., the virtual desktop client agent 727) may establish one or more communication channels with the host device 719 (e.g., the virtual delivery manager 731). The communication channels may, for example, be implemented based on any type of tunneling protocol, to allow the client device 717 in the client network 701 to communicate with the host device 719 in the host network 703 across the boundaries of the network 701 and/or the network 703. In some examples, the communication channels may comprise CITRIX Independent Computing Architecture (ICA) virtual channels. Additionally or alternatively, the communication channels may comprise micro-VPN channels that allow individual services (e.g., Windows services, Unix daemons, etc.) running on the client device 717 to communicate with corresponding service(s) running on the host device 719.

The virtual desktop 733 may implement one or more applications (e.g., application 735). The application 735 may comprise, for example, a web browser, an email application, a calendar application, a video player, a video application, a gaming application, a cloud storage application, a word processor, and/or any other type of application. The virtual delivery manager 731 may be configured to send the display of the application 735 to the client device 717 for output (e.g., on a screen of the client device 717).

In some examples, the application 735 may be redirected to the client device 717, to offload, from the host device 719 to the client device 717, some or all of the processing and/or the network, central processing unit (CPU), and/or random-access memory (RAM) usage associated with the application 735. The client device 717 may implement a redirected application 729 corresponding to the application 735. The redirected application 729 may perform some or all of the functions associated with the application 735. Additionally or alternatively, the client device 717 may be configured to overlay the display of the redirected application 729 over the display of the application 735 as received from the host device 719.

In some examples, the application 735 may comprise a web browser, and the redirected application 729 may comprise a redirected browser. Some or all of the functionalities of the web browser may be offloaded to the client device 717, and the redirected browser may be, for example, configured to perform the offloaded functionalities of the web browser. The redirected browser may comprise, for example, a browser engine, a layout engine, a rendering engine, and/or the like, and may be configured to render and/or process a retrieved web page (e.g., to transform Hypertext Markup Language (HTML) documents and other resources of a web page into an interactive visual representation). Additionally or alternatively, the redirected browser may be configured to cause output of the rendered web page (e.g., onto a screen of the client device 717). For example, the viewport of the rendered web page may be overlaid over the display of the web browser implemented on the host device 719 as received from the host device 719, so that the viewport of the web page rendered by the redirected browser on the client device 717 may be blended back into the display of the virtual desktop as received from the host device 719. Additionally or alternatively, the redirected browser running on the client device 717 may be configured to retrieve the web page from a corresponding source (e.g., a web server).

The application 735 (e.g., a web browser) may access resources (e.g., the resources 709B, 709D), for example, in response to requests from a user. For example, a user may enter, in the web browser, a uniform resource locator (URL) corresponding to the resource 709B (e.g., a first web server) or the resource 709D (e.g., a second web server). The application 735 may send a request to retrieve the resources based on a configuration file associated with the host network 703. The configuration file may indicate, for example, that the application 735 may directly send requests to the resource 709B, and/or that the application 735 may send requests to the resource 709D via the proxy server 713. In some example, the configuration file may comprise a proxy auto-config (PAC) file for the application 735 (e.g., a web browser). The configuration file may be configured for the application 735 by an administrator, and/or may be configured in other manners. In some examples, the configuration file may be retrieved from a host network configuration file device (e.g., host network configuration file device 723) that stores the configuration file for the host network 703, and may be automatically configured for the application 735. In some examples, the configuration file may be configured for the application 735 via a configuration file discovery protocol, such as the Web Proxy Auto-Discovery (WPAD) protocol. In some examples, the configuration file may also be obtained from Virtual Desktop—or Virtual Delivery Manager—specific configuration (which may also include instructions about how to access client-side resources, such as 709A and/or 709C). In some examples, data of the configuration file may be obtained from a combination of multiple sources. Additionally, the configuration file may include instructions about how to access client-side resources, such as 709A and/or 709C.

If the application 735 is redirected to the client device 717, the redirected application 729 (e.g., a redirected browser) may access resources (e.g., the resources 709A, 709C), for example, in response to requests from a user. For example, a user may enter, in the redirected browser, a URL corresponding to the resource 709A (e.g., a third web server) or the resource 709C (e.g., a fourth web server). The redirected application 729 may send a request to retrieve the resources based on a configuration file associated with the client network 701. The configuration file may indicate, for example, that the redirected application 729 may directly send requests to the resource 709A, and/or that the redirected application 729 may send requests to the resource 709C via the proxy server 711. In some example, the configuration file may comprise a PAC file for the redirected application 729 (e.g., a redirected browser). The configuration file may be configured for the redirected application 729 by an administrator, and/or may be configured in other manners. In some examples, the configuration file may be retrieved from a client network configuration file device (e.g., client network configuration file device 721) that stores the configuration file for the client network 701, and may be automatically configured for the redirected application 729. In some examples, the configuration file may be configured for the redirected application 729 via a configuration file discovery protocol, such as the WPAD protocol.

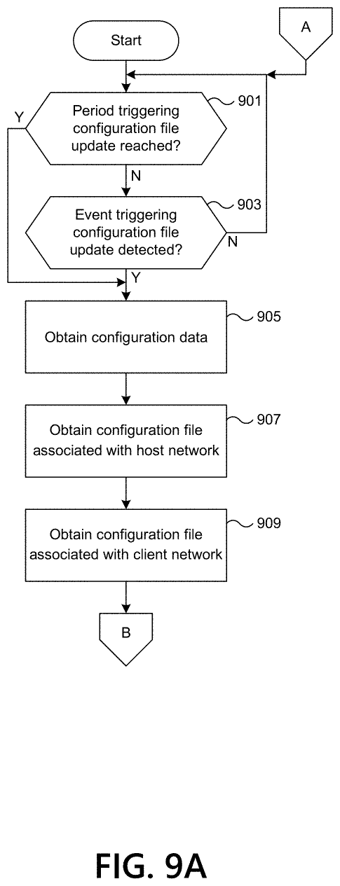

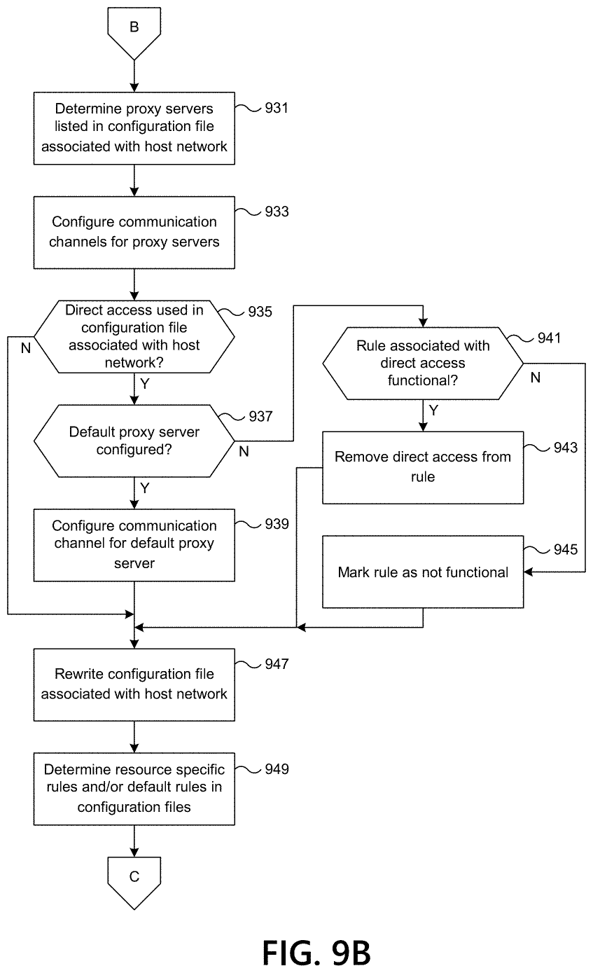

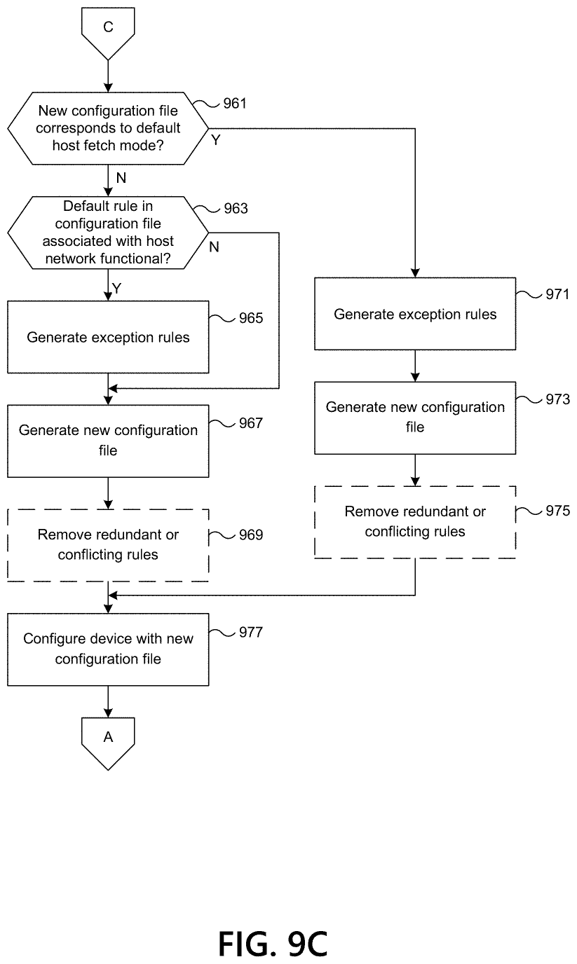

The configuration file generating device 725 may be configured to generate, based on the configuration file associated with the client network 701, the configuration file associated with the host network 703, and/or other configuration data (e.g., indicating access methods for particular URLs as received from the administrative device 737), a merged configuration file for use by the redirected application 729 running on the client device 717 to access various resources (e.g., the resources 709A-709D), as described in greater detail below in connection with FIGS. 9A-9C. The configuration file generating device 725 may be located in the client network 701, the host network 703, or any other network, and may be configured to enable communication with the client network 701, the host network 703, other networks, and/or various devices. Communication channels dedicated to transmitting traffic associated with accessing the various resources (e.g., the resources 709B, 709D) may be established between the client device 717 and the host device 719. The established communication channels may comprise, for example, a CITRIX ICA Port Forwarding virtual channel, a micro-VPN, and/or the like. The rules in the merged configuration file may be based on the established communication channels, and may indicate updated access methods using the communication channels to access resources associated with the host network 703. The rules in the merged configuration file may also indicate the preferred method(s) for accessing a particular resource.

A default proxy server (e.g., default proxy server 715) may be established in the host network 703. The default proxy server 715 may be used to process requests to access resources that are directly accessible by devices in the host network 703 (e.g., the resource 709B). As the access methods using the established communication channels indicated in the merged configuration file may be indicated as access methods via proxy servers, instead of access methods of direct access, the default proxy server 715 may be used to process and/or translate requests, from the client device 717 and for a resource otherwise directly accessible by devices in the host network 703, that may be in a format intended for receipt by a proxy server (e.g., HTTP requests directed to a proxy server), instead of by the resource itself (e.g., regular HTTP requests directed to a source device). In some examples, a proxy server (e.g., the default proxy server 715) or functionalities of the proxy server may be incorporated in the host device 719.

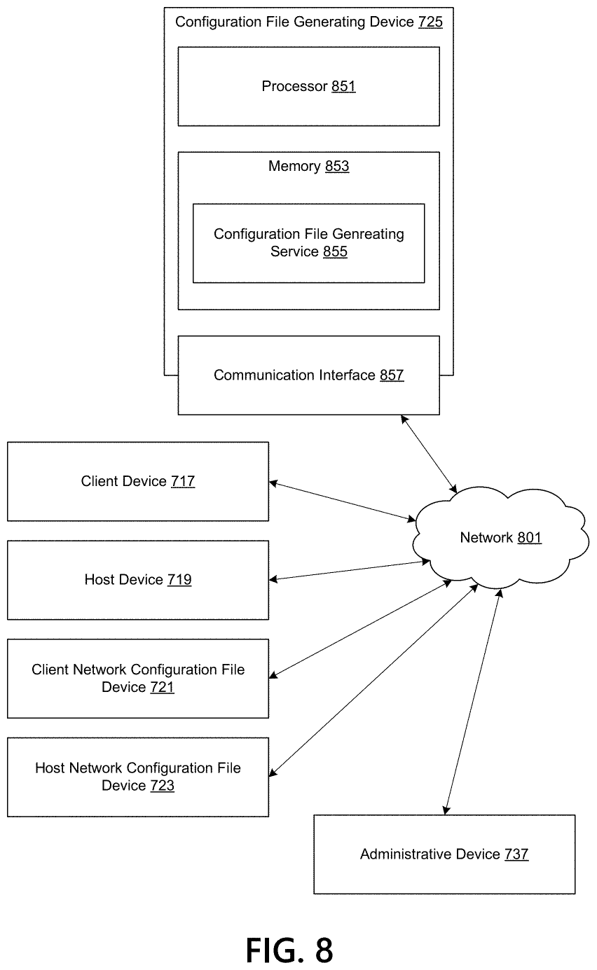

FIG. 8 is a schematic diagram showing an example system for generating merged configuration files. The system may comprise, for example, a network 801, the configuration file generating device 725, the client device 717, the host device 719, the client network configuration file device 721, the host network configuration file device 723, and/or the administrative device 737. The configuration file generating device 725, the client device 717, the host device 719, the client network configuration file device 721, the host network configuration file device 723, and/or the administrative device 737 may comprise one or more physical components, such as one or more processors, memory, one or more communication interfaces, and/or the like. The memory may store instructions that, when executed by the one or more processors, cause performance of the functions described herein.

In some examples, the client device 717 may include, incorporate, and/or implement one or more aspects of the client devices, mobile devices, and/or user devices discussed above. In some examples, the host device 719 may include, incorporate, and/or implement one or more aspects of the enterprise systems and/or management servers discussed above. Additionally or alternatively, the host device 719 may include, incorporate, and/or implement one or more aspects of the virtualization servers and/or other virtualization infrastructure discussed above and/or may communicate with one or more enterprise systems that include, incorporate, and/or implement one or more aspects of the virtualization servers and/or other virtualization infrastructure discussed above. Additionally, the host device 719 may incorporate a proxy server (e.g., the default proxy server 715) or functionalities of the proxy server. The client network configuration file device 721 may comprise a computing device that stores one or more configuration files (e.g., PAC files) associated with a client network (e.g., the client network 701). The host network configuration file device 723 may comprise a computing device that stores one or more configuration files (e.g., PAC files) associated with a host network (e.g., the host network 703). The administrative device 737 may comprise a computing device that stores configuration data (e.g., related to access methods for particular URLs). The configuration file generating device 725 may comprise a computing device that generates merged configuration files based on client network configuration files, host network configuration files, and/or other configuration data (e.g., related to access methods for particular URLs). The network 801 may comprise one or more local area networks, wide area networks, public networks, private networks, and/or sub-networks, and may interconnect the configuration file generating device 725, the client device 717, the host device 719, the client network configuration file device 721, the host network configuration file device 723, and/or the administrative device 737. In some examples, the administrative device 737 and/or the configuration file generating device 725, or functionalities thereof, may be incorporated in the host device 719 and/or the client device 717. For example, the administrative device 737 or functionalities thereof may be incorporated in the host device 719. The configuration file generating device 725 or functionalities thereof may be incorporated in the client device 717.

The configuration file generating device 725 may comprise at least one processor 851, memory 853, and at least one communication interface 857. The processor 851 may execute instructions stored in the memory 853 that cause the configuration file generating device 725 to perform one or more functions, such as generating merged configuration files and/or performing other functions, as described in greater detail below in connection with the algorithm(s) of FIGS. 9A-9C. The memory 853 may store a configuration file generating service 855, which may comprise instructions that enable the configuration file generating device 725 to provide one or more of these functions and/or other functions described below. The communication interface 857 may comprise one or more network interfaces via which the configuration file generating device 725 may communicate with one or more other systems and/or devices, such as the client device 717, the host device 719, the client network configuration file device 721, the host network configuration file device 723, and/or the administrative device 737.

FIGS. 9A-9C are flowcharts showing an example method for proxy configuration for multiple networks. The method may be performed, for example, by the system as described in connection with FIGS. 7-8. The steps of the method are described as being performed by particular component(s) and/or computing device(s) for the sake of simplicity, but the steps of the method may be performed by any other component(s) and/or computing device(s). The steps of the method may be performed by a single computing device or by multiple computing devices. One or more steps of the method may be omitted, added, and/or rearranged as desired by a person of ordinary skill in the art.

In step 901, a computing device (e.g., the configuration file generating device 725) may determine whether a period triggering a configuration file update has been reached. The computing device may be configured to periodically generate a new configuration file to be used by client devices (e.g., the client device 717) in a client network (e.g., the client network 701), in order to allow the client devices to access resources in the client network, a host network (e.g., the host network 703), a client proxy-accessible network (e.g., the client proxy-accessible network 705), and/or a host proxy-accessible network (e.g., the host proxy-accessible network 707). As described in more detail below, the new configuration file may be generated based on, for example, a configuration file associated with the client network, a configuration file associated with the host network, and/or other configuration data (e.g., related to access methods for particular URLs).

The period may comprise, for example, a one-second interval, a 30-second interval, a one-minute interval, a five-minute interval, a one-hour interval, a one-day interval, and/or the like. The period may be adjusted by an administrator and/or based on various factors, such as an average frequency at which the configuration file associated with the client network, the configuration file associated with the host network, and/or other configuration data are modified or updated. The computing device may, for example, set up a timer corresponding to the period, and if the timer expires, the computing device may determine that the period triggering a configuration file update has been reached. If the period triggering a configuration file update has not been reached (step 901: N), the method may proceed to step 903. If the period triggering a configuration file update has been reached (step 901: Y), the method may proceed to step 905.

In step 903, the computing device may determine whether an event triggering a configuration file update has been detected. The event may comprise, for example, a notification (e.g., from the client network configuration file device 721) or a determination (e.g., by the computing device) that the configuration file associated with the client network is changed, a notification (e.g., from the host network configuration file device 723) or a determination (e.g., by the computing device) that the configuration file associated with the host network is changed, a notification or a determination that other configuration data indicating access methods for particular URLs are changed, and/or the like. Additionally or alternatively, the event may comprise activation of a new client device in the client network, activation of a redirected application (e.g., the redirected application 729) by the client device, activation of a host device, a virtual delivery manager, a virtual desktop, and/or an application in a virtual desktop, and/or the like. The computing device may be configured to send and/or receive messages related to the event(s), and may detect the event based on the messages. For example, the client network configuration file device 721 may send, to the computing device, a message indicating that the configuration file associated with the client network has been updated. In response to receiving the message, the computing device may detect the event triggering a configuration file update. In some examples, a client device (e.g., when activated) may send, to the computing device, a message indicating that the client device has been activated. In response to receiving the message, the computing device may detect the event triggering a configuration file update. If the event triggering a configuration file update has not been detected (step 903: N), the method may repeat step 901. If the event triggering a configuration file update has been detected (step 903: Y), the method may proceed to step 905.

In step 905, the computing device may obtain configuration data (e.g., data indicating access methods for particular URLs). The configuration data may be received, for example, from an administrative device associated with the virtual delivery manager 731 and/or the virtual desktop 733, such as the administrative device 737. The configuration data, in addition to the configuration file associated with the host network and the configuration file associated with the client network, may indicate access methods for particular URLs. An administrator associated with the virtual delivery manager 731 and/or the virtual desktop 733 may enter into the administrative device 737 access methods for particular URLs, which may be sent to the computing device. The following shows an example table of the configuration data.

TABLE 1

| URL | Access method |
|---|---|
| asdf.com | client fetch |
| zxcv.com | host fetch |
| qwerty.com | client fetch |
| foo.com | use default rule |

The example configuration data table indicates that the URL “asdf.com” is to be accessed via the client network, that the URL “zxcv.com” is to be accessed via the host network, that the URL “qwerty.com” is to be accessed via the client network, and that the URL “foo.com” is to be accessed according to the default access method of a configuration file used by the accessing device.

In step 907, the computing device may obtain the configuration file associated with the host network. The configuration file associated with the host network may be used, for example, by devices (e.g., the host device 719) in the host network and/or applications implemented on the devices to access resources (e.g., the resources 709B, 709D). The configuration file associated with the host network may indicate (e.g., using Javascript functions, etc.) the access methods for various URLs. For example, the configuration file associated with the host network 703 may indicate that a URL corresponding to the resource 709B may be directly accessed, and that a URL corresponding to the resource 709D may be accessed via the proxy server 713. The configuration file associated with the host network may comprise, for example, a PAC file. The computing device may obtain the configuration file associated with the host network, for example, by retrieving the configuration file from the host network configuration file device 723, a device (e.g., the host device 719) in the host network, and/or other device(s) that store the configuration file associated with the host network. For example, the computing device may send, to a corresponding device that stores the configuration file associated with the host network, a request for the configuration file associated with the host network. In response to the request, the corresponding device may send, to the computing device, the configuration file associated with the host network. In some examples, the configuration file associated with the host network may be pushed to the computing device without the computing device initiating the request.

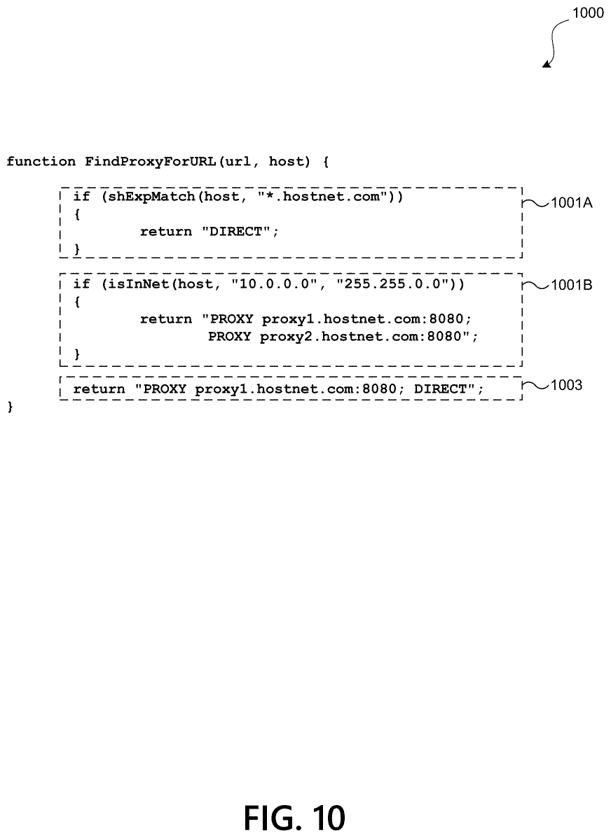

FIG. 10 shows an example configuration file 1000 associated with a host network. Referring to FIG. 10, the configuration 1000 may comprise, for example, a PAC file associated with the host network 703. The configuration file 1000 may comprise, for example, a Javascript function “FindProxyForURL (URL, host),” where the first argument “URL” may be a URL of interest (e.g., a URL to be accessed by a web browser), and the second argument “host” may be the host name derived from the URL. The function may return one or more access methods for a particular input URL, and may cause the application to use a particular proxy server or to connect directly for accessing the URL. For example, a returned value “DIRECT” may indicate that the input URL is to be accessed directly. A returned value “PROXY proxy1.hostnet.com:8080” may indicate that the input URL is to be accessed via a proxy server proxy1.hostnet.com:8080.

In some examples, a returned value may comprise two or more access methods, such as “PROXY proxy1.hostnet.com:8080; PROXY proxy2.hostnet.com:8080.” The application may, based on such a returned value, use one of the access methods (e.g., the first access method “PROXY proxy1.hostnet.com:8080”). The application may, based on such a returned value, use the other one(s) of the access methods (e.g., the second access method “PROXY proxy2.hostnet.com:8080”), if the application fails to obtain access to the resource corresponding to the URL using the one access method.

The configuration file 1000 may comprise one or more resource specific rules (e.g., resource specific rules 1001A-1001B), and a default rule (e.g., default rule 1003). The resource specific rules 1001A-1001B may indicate the access method(s) to be used for specific URLs, host names, and/or network addresses (e.g., IP addresses). The default rule 1003 may indicate the access method(s) to be used if the input URL does not satisfy any of the resource specific rules 1001A-1001B.

Referring back to FIG. 9A, in step 909, the computing device (e.g., the configuration file generating device 725) may obtain the configuration file associated with the client network. The configuration file associated with the client network may be used, for example, by devices (e.g., the client device 717) in the client network and/or applications implemented on the devices to access resources (e.g., the resources 709A, 709C). The configuration file associated with the client network may indicate (e.g., using Javascript functions, etc.) the access methods for various URLs. For example, the configuration file associated with the client network 701 may indicate that a URL corresponding to the resource 709A may be directly accessed, and that a URL corresponding to the resource 709C may be accessed via the proxy server 711. The configuration file associated with the client network may comprise, for example, a PAC file. The computing device may obtain the configuration file associated with the client network, for example, by retrieving the configuration file from the client network configuration file device 721, a device (e.g., the client device 717) in the client network, and/or other device(s) that store the configuration file associated with the client network. For example, the computing device may send, to a corresponding device that stores the configuration file associated with the client network, a request for the configuration file associated with the client network. In response to the request, the corresponding device may send, to the computing device, the configuration file associated with the client network. In some examples, the configuration file associated with the client network may be pushed to the computing device without the computing device initiating the request.

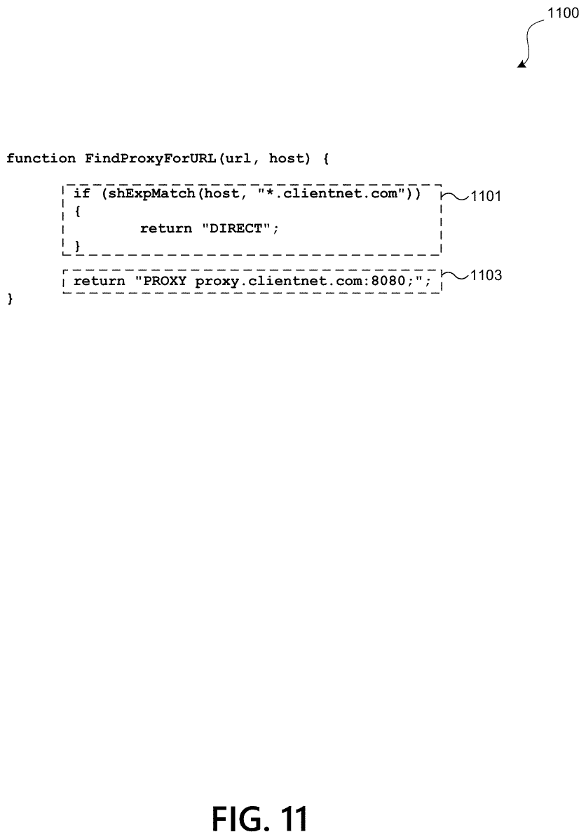

FIG. 11 shows an example configuration file 1100 associated with a client network. Referring to FIG. 11, the configuration 1100 may comprise, for example, a PAC file associated with the client network 701. The configuration file 1100 may comprise similar components as the configuration file 1000. The configuration file 1100 may comprise, for example, a Javascript function “FindProxyForURL (URL, host),” where the first argument “URL” may be a URL of interest (e.g., a URL to be accessed by a web browser), and the second argument “host” may be the host name derived from the URL. The function may return one or more access methods for a particular input URL, and may cause the application to use a particular proxy server or to connect directly for accessing the URL. For example, a returned value “DIRECT” may indicate that the input URL is to be accessed directly. A returned value “PROXY proxy1.clientnet.com:8080” may indicate that the input URL is to be accessed via a proxy server proxy1.clientnet.com:8080.

The configuration file 1100 may comprise one or more resource specific rules (e.g., resource specific rule 1101), and a default rule (e.g., default rule 1103). The resource specific rule 1101 may indicate the access method(s) to be used for specific URLs, host names, and/or network addresses (e.g., IP addresses). The default rule 1103 may indicate the access method(s) to be used if the input URL does not satisfy the resource specific rule 1101.

Referring to FIG. 9B, in step 931, the computing device may determine one or more proxy servers listed in the configuration file associated with the host network. The computing device may process the configuration file associated with the host network, for example, based on the programming language in which the configuration file is written. The computing device may use, for example, a lexical analyzer, a syntax and/or semantic analyzer, and/or any other parser to process the configuration file associated with the host network. In some examples, the computing device may identify the proxy servers listed in the configuration file based on determining the value following the indicator “PROXY” (e.g., as shown in the configuration file 1000). For example, based on processing the configuration file 1000, the computing device may determine two proxy servers proxy1.hostnet.com:8080 and proxy2.hostnet.com:8080 are listed in the configuration file 1000.

In step 933, the computing device may configure communication channels for the proxy servers as determined in step 931. The computing device may configure the communication channels to allow a client device (e.g., the client device 717) to communicate with the proxy servers for accessing resources accessible via the proxy servers outside or otherwise not accessible with the network of the client device (e.g., the client network 701). In some examples, the communication channels may comprise CITRIX ICA Port Forwarding virtual channels.

For example, the client device may implement one or more services (e.g., Windows services, Unix daemons, etc.) configured to communicate with one or more services running on the host device. The one or more services running on the client device may be accessed via the loopback network interface of the client device (e.g., localhost). One or more ports of the loopback network interface of the client device may be configured to correspond to the one or more services running on the client device.

The one or more services running on the client device may communicate with the one or more services running on the host device via the communication channels, such as CITRIX ICA Port Forwarding virtual channels. The communication channel(s) may be dedicated to transmitting traffic between a service running on the client device and a corresponding service running on the host device. The communication channel may allow the service running on the client device to send traffic to the service running on the host device across the boundaries of the client network and/or the host network. The one or more services running on the host device may be configured to forward received messages to the corresponding proxy servers. Additionally or alternatively, the communication channels may comprise micro-VPN channels that allow individual services running on the client device to communicate with corresponding service(s) running on the host device across the boundaries of the client network and/or the host network.

The following shows an example table related to configuring the communication channels. For example, localhost of a client device with port number 3456 may be used to access a client service 1 running on the client device. A communication channel (e.g., CITRIX ICA Port Forwarding virtual channel) may be established between the client service 1 and a host service 1 running on the host device. A message addressed to localhost:3456 may be directed to the client service 1, which may forward the message to host service 1 via the established communication channel. The host service 1 may receive the message, and may send the message to the proxy server proxy1.hostnet.com:8080.

TABLE 2

| Port of | Service on | Service on | |
|---|---|---|---|
| client device | client device | host device | Target proxy server |
| localhost: | client | host | proxy1.hostnet.com: |
| 3456 | service 1 | service 1 | 8080 |
| localhost: | client | host | proxy2.hostnet.com: |
| 3457 | service 2 | service 2 | 8080 |

The computing device may, for example, determine the correspondences among the components related to the communication channels, as shown in the example table above. The computing device may send, to the client device, the host device, and/or the proxy server(s), instructions to configure the communication channels (e.g., according to the determined correspondences).

In step 935, the computing device may determine whether a method of direct access is used in the configuration file associated with the host network. For example, if the configuration file associated with the host network comprises a PAC file associated with the host network, the computing device may determine whether the access method “DIRECT” is used in the PAC file, which may indicate a method of direct access. The computing device may process and/or parse the configuration file associated with the host network, and may identify any indication of a direct access method. If a method of direct access is not used in the configuration file associated with the host network (step 935: N), the method may proceed to step 947. If a method of direct access is used in the configuration file associated with the host network (step 935: Y), the method may proceed to step 937.

In step 937, the computing device may determine whether a default proxy server is configured for a method of direct access indicated in the configuration file associated with the host network. A default proxy server may be used to receive, from the client device, requests to access resources that are available and/or directly accessible by a device in the host network. A method of direct access as indicated in the configuration file associated with the host network may cause a device in the host network to directly access corresponding resources. As further discussed below, when the method of direct access as indicated in the configuration file associated with the host network is merged with the configuration file associated with client network (and/or merged with other configuration data) to generate a merged configuration file to be used by a client device in the client network, the method of direct access may be modified into an access method via a proxy server in the merged configuration file. Based on the modified access method, the client device may expect to communicate with a proxy server, and may generate and/or send messages in a format intended for receipt by a proxy server. The default proxy server may be configured to receive and process the messages, from the client device, in a format intended for receipt by a proxy server. In some examples, the computing device may prompt an administrator to configure a default proxy server in the host network. In some examples, the default proxy server may comprise functionalities, related to the default proxy server, integrated into the host device and/or a service running on the host device, such as a service running on the host device configured to process messages in a format addressed to a proxy server.

If a default proxy server is configured (step 937: Y), the method may proceed to step 939. In step 939, the computing device may configure a communication channel for the default proxy server. The following shows an example table related to configuring the communication channel for the default proxy server. The communication channel for the default proxy server may be configured in a similar manner as the communication channel(s) are configured in step 933.

TABLE 3

| Port of | Service on | Service on | |
|---|---|---|---|
| client device | client device | host device | Target proxy server |
| localhost: | client | host | defaultproxy.hostnet.com: |
| 3458 | service 3 | service 3 | 8080 (“DIRECT”) |

If a default proxy server is not configured (step 937: N), the method may proceed to step 941. In step 941, the computing device may determine whether a rule associated with (e.g., indicating) a method of direct access in the configuration file associated with the host network is functional. For example, the computing device may determine whether the rule indicates two or more access methods, including the method of direct access. For example, a rule may indicate the access method(s) to be “PROXY proxy1.hostnet.com:8080; DIRECT.” The computing device may determine that this rule indicates one access method of “PROXY proxy1.hostnet.com:8080” and another access method of “DIRECT.” In some examples, a rule may indicate the access method to be only “DIRECT.”

If the rule indicates access method(s) to be only a method of direct access, the computing device may determine that the rule is not functional. If the rule indicates the method of direct access and one or more methods of access via a proxy server, the computing device may determine that the rule is functional (e.g., the one or more methods of access via a proxy server may still be used). In some examples, if the rule indicates the method of direct access and one or more methods of access via a proxy server, the computing device may further consider, for example, an average rate of successful access using each of the one or more methods of access via a proxy server. The computing device may determine that the rule is not functional, for example, if the average rate of successful access using each of the one or more methods of access via a proxy server is below a threshold of successful access (e.g., 80%). Step 941 (and corresponding steps 943 or 945) may be performed for one or more rules associated with a method of direct access in the configuration file associated with the host network.

If the rule associated with a method of direct access in the configuration file associated with the host network is functional (step 941: Y), the method may proceed to step 943. In step 943, the computing device may remove the method of direct access from the rule as determined in step 941. For example, if a rule indicates the access method(s) to be “PROXY proxy1.hostnet.com:8080; DIRECT,” the computing device may remove “DIRECT” from the rule, so that the rule indicates the access method(s) to be “PROXY proxy1.hostnet.com:8080.”

If the rule associated with a method of direct access in the configuration file associated with the host network is not functional (step 941: N), the method may proceed to step 945. In step 945, the computing device may mark the rule as determined in step 941 as not functional. For example, the computing device may store a status of the rule in the memory of the computing device. Additionally or alternatively, the computing device may tag the rule with an indication that the rule is not functional. The marking of a rule as non-functional may, for example, allow the computing device (e.g., in subsequent processes) to determine not to use the rule for generating the new configuration file. In some examples, if the rule associated with a method of direct access in the configuration file associated with the host network is not functional, the computing device may remove the rule from the configuration file associated with the host network, so that the rule might not be used for generating the new configuration file.

In step 947, the computing device may rewrite the configuration file associated with the host network. The computing device may replace the identifiers of proxy servers and/or the identifiers of the direct access method in the configuration file associated with the host network with identifiers of the communication channels corresponding to the proxy servers and/or the direct access method. For example, the computing device may replace the identifiers of proxy servers and/or the identifiers of the direct access method with port numbers of the loopback network interface of the client device.

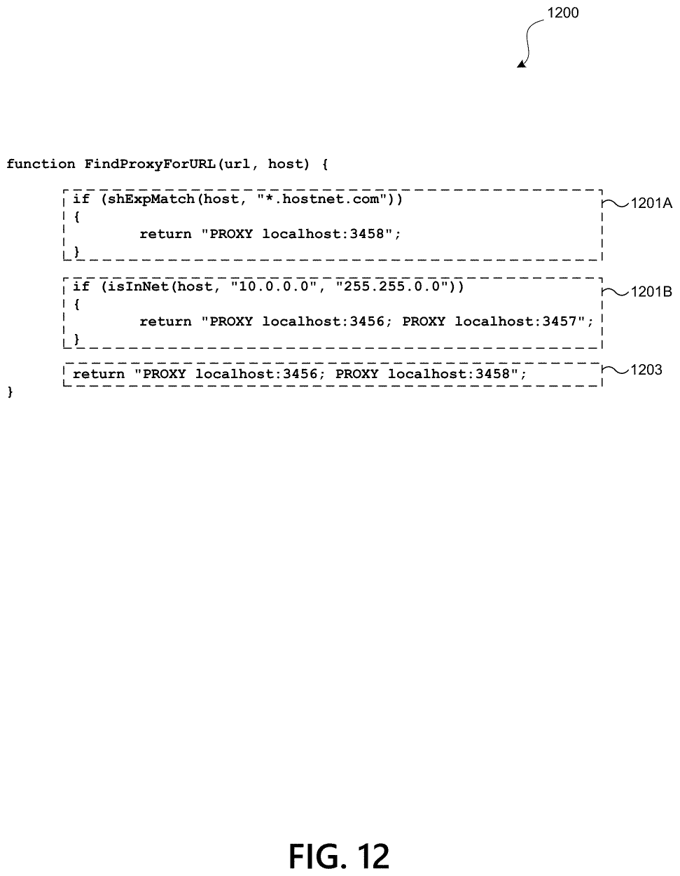

FIG. 12 shows an example rewritten configuration file 1200 associated with a host network. Referring to FIG. 12, the rewritten configuration file 1200 may correspond to the output of rewriting the configuration file 1000. For example, the proxy server host names and port numbers are replaced with the localhost and port numbers. The “DIRECT” access method is replaced with the localhost and a corresponding port number. The rewritten configuration file 1200 may be generated by rewriting the configuration file 1000 based on a mapping of proxy servers to identifiers associated with the communication channels coupled to the proxy servers, such as indicated in the tables discussed above in connection with step 933, 939 (e.g., Table-2, Table-3).

The rewritten configuration file 1200 may comprise one or more resource specific rules (e.g., resource specific rule 1201A-1201B), and a default rule (e.g., default rule 1203). The resource specific rules 1201A-1201B may indicate the access method(s) to be used for specific URLs, host names, and/or network addresses (e.g., IP addresses). The default rule 1203 may indicate the access method(s) to be used if the input URL does not satisfy the resource specific rules 1201A-1201B.

Referring back to FIG. 9B, in step 949, the computing device may determine the resource specific rules and/or the default rules in the configuration files. For example, the computing device may determine the resource specific rules and/or the default rule in the configuration file associated with the client network. Additionally, the computing device may determine the resource specific rules and/or the default rule in the configuration file associated with the host network, as may be modified in step 943 and/or rewritten in step 947. The computing device may use, for example, a lexical analyzer, a syntax and/or semantic analyzer, and/or any other parser to process the configuration files and to identify the different types of rules in the configuration files.

Referring to FIG. 9C, in step 961, the computing device may determine whether a new configuration file to be generated corresponds to a default host fetch mode. The new configuration file may be generated to comprise one or more resource specific rules and a default rule. The default rule in the new configuration file may, for example, indicate an access method for a URL if the URL does not satisfy any of the resource specific rules in the new configuration file. If the new configuration file corresponds to a default host fetch mode, the default rule of the new configuration file may indicate one or more access methods via the host network (e.g., the default rule of the new configuration file may be based on the default rule in the configuration file associated with the host network). If the new configuration file corresponds to a default client fetch mode, the default rule of the new configuration file may indicate one or more access methods via the client network (e.g., the default rule of the new configuration file may be based on the default rule in the configuration file associated with the client network).

The computing device may determine, based on various factors, whether the new configuration file to be generated corresponds to a default host fetch mode. For example, the computing device may determine whether the default rule in the configuration file associated with the host network is functional. As discussed in connection with step 945, the computing device may mark a rule in the configuration file associated with the host network as not functional (e.g., if the rule indicates only a method of direct access and a default proxy server is not configured for the method of direct access). For example, the computing device may store a status of the rule in the memory of the computing device. Additionally or alternatively, the computing device may tag the rule with an indication that the rule is not functional. If the default rule in the configuration file associated with the host network is marked as not functional, the computing device may determine that the new configuration file does not correspond to a default host fetch mode (e.g., as the default rule in the configuration file associated with the host network might not be able to be used to generate the default rule in the new configuration file). If the default rule in the configuration file associated with the host network is functional (e.g., if the default rule is not marked as not functional in step 945), the computing device may determine that the new configuration file corresponds to a default host fetch mode. For example, if the default rule in the configuration file associated with the host network indicates an access method of direct access, and if a default proxy server is configured for the access method, the computing device may determine that the new configuration file corresponds to a default host fetch mode.

Additionally or alternatively, if the default rule in the configuration file associated with the host network is functional, the computing device may determine, based on input from an administrator, the default fetch mode for the new configuration file. For example, the administrator may set the default fetch mode for the new configuration file to be one of a default host fetch mode or a default client fetch mode. Additionally or alternatively, if the default rule in the configuration file associated with the host network is functional, the computing device may determine, based on policy information and/or network conditions, the default fetch mode for the new configuration file. For example, the computing device may monitor the conditions of the client network and the host network. The monitored network conditions may comprise, for example, the throughput, load, available bandwidth, bandwidth usage rate, latency, congestion level, and/or packet loss rate of one or more devices in the network, one or more servers in the network, one or more communication links of the network, and/or the entirety of the network. The monitoring of the network conditions may be performed periodically, continuously, and/or in any other desired manner the computing device may determine to use a default host fetch mode, for example, if the condition of the client network is worse than the condition of the host network. The computing device may determine to use a default client fetch mode, for example, if the condition of the client network is better than the condition of the host network.

If the new configuration file does not correspond to a default host fetch mode (e.g., but rather corresponds to a default client fetch mode) (step 961: N), the method may proceed to step 963. In step 963, the computing device may determine whether the default rule in the configuration file associated with the host network is functional. As discussed in connection with step 945, the computing device may mark a rule in the configuration file associated with the host network as not functional (e.g., if the rule indicates only a method of direct access and a default proxy server is not configured for the method of direct access). The computing device may determine that the default rule in the configuration file associated with the host network is functional if the default rule has not been marked as not functional.

If the default rule in the configuration file associated with the host network is functional (step 963: Y), the method may proceed to step 965. In step 965, the computing device may generate exception rules based on the configuration data obtained in step 905 and/or based on the default rule in the configuration file associated with the host network. In the default client fetch mode for the new configuration file, a URL may be indicated to be accessed by default using the client network. URL(s) as indicated in the configuration data obtained in step 905 to be accessed using the host network may be written into exception rules for the new configuration file. For example, the example configuration data table as described above and as shown below indicates that the URL “zxcv.com” is to be accessed via the host network. The computing device may generate an exception rule indicating that the URL “zxcv.com” is to be accessed according to the access method(s) indicated by the default rule in the configuration file associated with the host network.

TABLE 4

| URL | Access method |
|---|---|
| zxcv.com | host fetch |

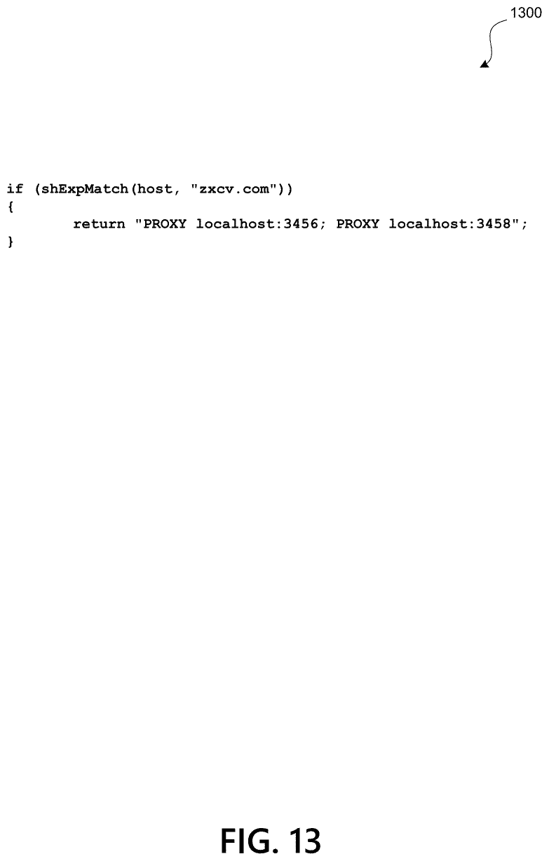

FIG. 13 shows an example exception rule 1300 for a default client fetch mode. Referring to FIG. 13, the exception rule 1300 may indicate that if a URL (and/or a host name derived from the URL) matches “zxcv.com,” access methods “PROXY localhost:3456; PROXY localhost:3458” may be used. The access methods in the exception rule 1300 may correspond to the access methods indicated by the default rule 1203 in the rewritten configuration file 1200 associated with the host network.

If the default rule in the configuration file associated with the host network is not functional (step 963: N), the method may proceed to step 967. In step 967, the computing device may generate the new configuration file. The new configuration file may be generated by merging the configuration file associated with the host network as obtained in step 907, the configuration file associated with the client network as obtained in step 909, and/or the configuration data as obtained in step 905. For example, the computing device may generate the new configuration file to include the exception rules as determined in step 965 (if any) (e.g., the exception rule 1300), the resource specific rules in the configuration file associated with the client network as determined in step 949 (e.g., the resource specific rule 1101), the resource specific rules in the rewritten configuration file associated with the host network as determined in step 949 (e.g., the rewritten resource specific rules 1201A-1201B), and the default rule in the configuration file associated with the client network as determined in step 949 (e.g., the default rule 1103).

The new configuration file may comprise the rules in the order as discussed above, and/or in any other order as desired by a person of ordinary skill in the art. In some examples, an administrator may modify the order in which the rules are organized. As the new configuration file may be in the default client fetch mode, the default rule of the configuration file associated with the client network may be placed at the end of the new configuration file, so that it may be treated as the default rule of the new configuration file. In some examples, the computing device might not include, in the new configuration file, a rule that was marked as not functional in step 945. For example, if one or more of the resource specific rules in the rewritten configuration file associated with the host network were marked as not functional, the computing device might not include, in the new configuration file, the one or more of the resource specific rules.

In step 969, the computing device may remove redundant or conflicting rules. In some examples, the new configuration file may comprise multiple rules indicating access method(s) for the same URL. If the multiple rules are redundant with each other (e.g., if the multiple rules indicate the same access method(s) for the same URL), the computing device may remove, from the new configuration file, one or more of the multiple rules. For example, the computing device may remove one or more of the multiple rules so that only one of the multiple rules remains in the new configuration file. If the multiple rules are conflicting with each other (e.g., if the multiple rules indicate different access method(s) for the same URL), the computing device may, for example, select one of the multiple rules as indicating preferred access method(s), and remove the not selected one or more of the multiple rules. The computing device may select the one preferred rule based on various factors, such as policy information from an administrator, network condition information related to the client network and/or the host network, an average rate of successful access using the access method(s) indicated in the rule, and/or the like. Step 969 is optional and might not be performed in some cases.

If the new configuration file corresponds to a default host fetch mode (step 961: Y), the method may proceed to step 971. In step 971, the computing device may generate exception rules based on the configuration data obtained in step 905 and/or based on the default rule in the configuration file associated with the client network. In the default host fetch mode for the new configuration file, a URL may be indicated to be accessed by default using the host network. URL(s) as indicated in the configuration data obtained in step 905 to be accessed using the client network may be written into exception rules for the new configuration file. For example, the example configuration data table as described above and as shown below indicates that the URL “asdf.com” is to be accessed via the client network and that the URL “qwerty.com” is to be accessed via the client network. The computing device may generate exception rules indicating that the URLs “asdf.com” and “qwerty.com” are to be accessed according to the access method(s) indicated by the default rule in the configuration file associated with the client network.

TABLE 5

| URL | Access method |
|---|---|
| asdf.com | client fetch |
| qwerty.com | client fetch |

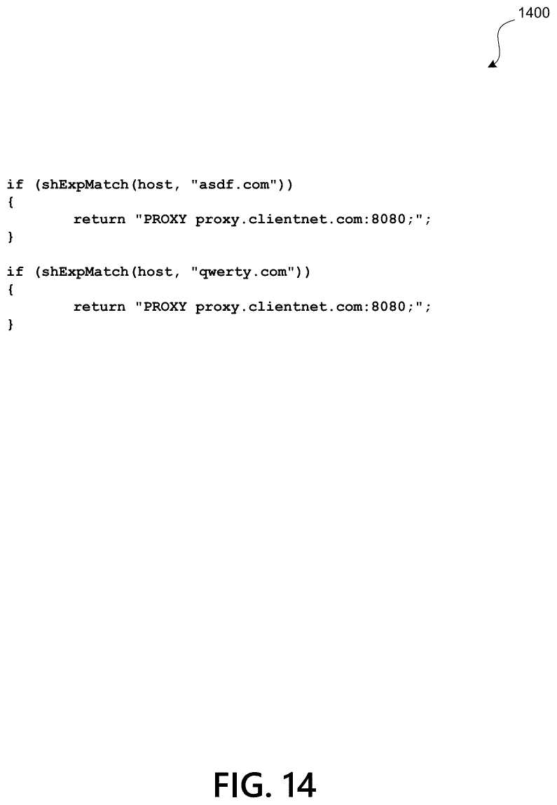

FIG. 14 shows example exception rules 1400 for a default host fetch mode. Referring to FIG. 14, the exception rules 1400 may indicate that if a URL (and/or a host name derived from the URL) matches “asdf.com,” a access method “PROXY proxy.clientnet.com:8080” may be used, and that if a URL (and/or a host name derived from the URL) matches “qwerty.com,” a access method “PROXY proxy.clientnet.com:8080” may be used. The access method in the exception rules 1400 may correspond to the access method indicated by the default rule 1103 in the configuration file 1100 associated with the client network.

Referring back to FIG. 9C, in step 973, the computing device may generate the new configuration file. The new configuration file may be generated by merging the configuration file associated with the host network as obtained in step 907, the configuration file associated with the client network as obtained in step 909, and/or the configuration data as obtained in step 905. For example, the computing device may generate the new configuration file to include the exception rules as determined in step 971 (if any) (e.g., the exception rules 1400), the resource specific rules in the rewritten configuration file associated with the host network as determined in step 949 (e.g., the rewritten resource specific rules 1201A-1201B), the resource specific rules in the configuration file associated with the client network as determined in step 949 (e.g., the resource specific rule 1101), and the default rule in the rewritten configuration file associated with the host network as determined in step 949 (e.g., the rewritten default rule 1203).

The new configuration file may comprise the rules in the order as discussed above, and/or in any other order as desired by a person of ordinary skill in the art. In some examples, an administrator may modify the order in which the rules are organized. As the new configuration file may be in the default host fetch mode, the default rule of the configuration file associated with the host network may be placed at the end of the new configuration file, so that it may be treated as the default rule of the new configuration file. In some examples, the computing device might not include, in the new configuration file, a rule that was marked as not functional in step 945. For example, if one or more of the resource specific rules in the rewritten configuration file associated with the host network were marked as not functional, the computing device might not include, in the new configuration file, the one or more of the resource specific rules.

In step 975, the computing device may remove redundant or conflicting rules. In some examples, the new configuration file may comprise multiple rules indicating access method(s) for the same URL. If the multiple rules are redundant with each other (e.g., if the multiple rules indicate the same access method(s) for the same URL), the computing device may remove, from the new configuration file, one or more of the multiple rules. For example, the computing device may remove one or more of the multiple rules so that only one of the multiple rules remains in the new configuration file. If the multiple rules are conflicting with each other (e.g., if the multiple rules indicate different access method(s) for the same URL), the computing device may, for example, select one of the multiple rules as indicating preferred access method(s), and remove the not selected one or more of the multiple rules. The computing device may select the one preferred rule based on various factors, such as policy information from an administrator, network condition information related to the client network and/or the host network, an average rate of successful access using the access method(s) indicated in the rule, and/or the like. Step 975 is optional and might not be performed in some cases.

In step 977, the computing device may configure a client device with the new configuration file. For example, the computing device may send the new configuration file to a client device (e.g., the client device 717), and may instruct the client device and/or particular applications running on the client device (e.g., the redirected application 729) to use the new configuration file when requesting access to resources. In some examples, an application running on a client device may use the Web Proxy Auto-Discovery Protocol (WPAD), which may use Dynamic Host Configuration Protocol (DHCP) and/or Domain Name System (DNS) servers to provide the location of the configuration file (e.g., PAC file) to the client device. For such an application, a new DNS server may be configured to provide the storage location of the new configuration file to the application (e.g., in response to a WPAD request from the application). The application may be configured to send WPAD requests to the new DNS server, and may send other requests to the original DNS server(s). In some examples, the computing device may generate a new configuration file for use by a host device, and the computing device may configure a host device with the new configuration file. In such a situation, a default proxy server or functionalities thereof may be established in the client network, communication channels may be established between the client device and the host device, identifiers of proxy servers and/or identifiers of direct access methods indicated in the configuration file associated with the client network may be replaced with identifiers associated with the established communication channels, and the new configuration file may be generated by merging the rewritten configuration file associated with the client network, the configuration file associated with the host network, and/or other configuration data, in a manner that is symmetrical to how the new configuration file may be generated for use by a client device.

If the client device 717 is configured with the new configuration file, the client device 717 may request access to resources associated with the client network (e.g., the client network 701) and/or resources associated with the host network (e.g., the host network 703). For example, the client device 717 may request access to the resource 709A directly (e.g., based on either a resource specific rule or a default rule, in the new configuration file, indicating an access method of direct access, such as “DIRECT”). In some examples, the client device 717 may request access to the resource 709B via a communication channel (e.g., a Port Forwarding virtual channel) between the client device 717 and the host device 719. The resource 709B may be accessed directly by a device in the host network 703 according to an access method of direct access as indicated in the configuration file associated with the host network 703, and may be accessed by the client device 717 via the communication channel using the default proxy server 715 according to an access method via a proxy server (e.g., a port, of the loopback network interface of the client device 717, communicatively coupled to the default proxy server 715), indicated in the new configuration file, as rewritten from the access method of direct access indicated in the configuration file associated with the host network 703.

In some examples, the client device 717 may request access to the resource 709C via the proxy server 711 in the client network 701 (e.g., based on either a resource specific rule or a default rule, in the new configuration file, indicating an access method via the proxy server 711). In some examples, the client device 717 may request access to the resource 709D via a communication channel (e.g., a Port Forwarding virtual channel) between the client device 717 and the host device 719. The resource 709D may be accessed by the client device 717 via the communication channel using the proxy server 713 according to an access method via a proxy server (e.g., a port, of the loopback network interface of the client device 717, communicatively coupled to the proxy server 713) as indicated in the new configuration file.

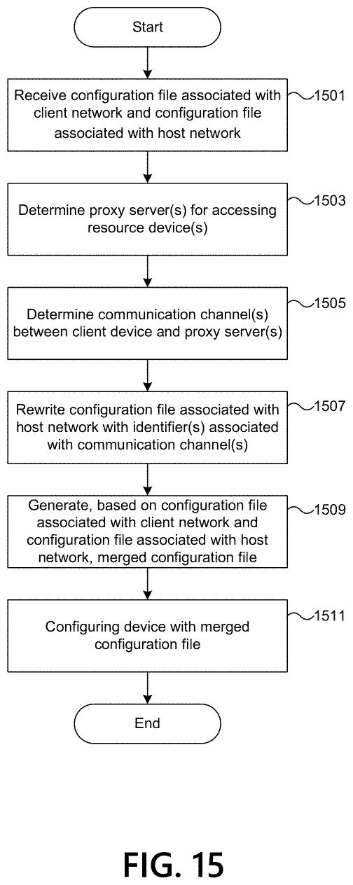

FIG. 15 is a flowchart showing an example method for providing a merged configuration file. In step 1501, a computing device may receive a configuration file associated with a client network and a configuration file associated with a host network, as described above in greater detail in connection with, for example, steps 907 and 909 of FIG. 9A. In step 1503, the computing device may determine, based on the configuration file associated with the host network, one or more proxy servers, in the host network, for accessing one or more resource devices, as described above in greater detail in connection with, for example, step 931 of FIG. 9B. In step 1505, the computing device may determine one or more communication channels between a client device in the client network and the one or more proxy servers, as described above in greater detail in connection with, for example, steps 933 and 939 of FIG. 9B. For example, the computing device may determine correspondences among port numbers of the loopback network interface of the client device, services running on the client device, services running on the host device, and the one or more proxy servers. The computing device may determine the communication channels for communicatively coupling the port numbers of the loopback network interface of the client device with the one or more proxy servers. In step 1507, the computing device may rewrite the configuration file associated with the host network with one or more identifiers associated with the one or more communication channels, as described above in greater detail in connection with, for example, step 947 of FIG. 9B. In step 1509, the computing device may generate, based on the configuration file associated with the client network and the configuration file associated with the host network, a merged configuration file, as described above in greater detail in connection with, for example, steps 967 and 973 of FIG. 9C. In step 1511, the computing device may cause configuration of the client device with the merged configuration file, as described above in greater detail in connection with, for example, step 977 of FIG. 9C. Additionally or alternatively, the computing device may generate a new configuration file for use by a host device, and the computing device may configure a host device with the new configuration file, as described above in greater detail in connection with, for example, step 977 of FIG. 9C.

The following paragraphs (M1) through (M13) describe examples of methods that may be implemented in accordance with the present disclosure.

(M1) A method comprising: receiving, by a computing device, a plurality of configuration files, the configuration files including a first configuration file of a client network and a second configuration file of a host network, the second configuration file including at least one identifier configured to enable direct access to a resource of the host network; generating, by the computing device, a merged configuration file for a client device based on the first configuration file and second configuration file, the merged configuration file is configured to replace the at least one identifier of the second configuration file with an identifier configured to enable the client device to access the resource of the host network via a proxy device; and configuring, by the computing device, the client device based on the merged configuration file, wherein the configuration of the client device enables an application executable on the client device to access resources of the client network or the host network.

(M2) A method may be performed as described in paragraph (M1) further comprising: determining, based on the first configuration file of the client network, one or more first resource specific rules indicating one or more uniform resource locators (URLs) and one or more access methods corresponding to the one or more URLs; and determining, based on the first configuration file of the client network, a first default rule indicating one or more access methods corresponding to URLs other than the one or more URLs.

(M3) A method may be performed as described in any of paragraphs (M1) through (M2) further comprising: determining, based on the second configuration file of the host network, one or more second resource specific rules associated with the host network; and determining, based on the second configuration file of the host network, a second default rule, associated with the host network, of the one or more second resource specific rules.

(M4) A method may be performed as described in any of paragraphs (M1) through (M3) wherein the merged configuration file indicates a default access instruction based on the first default rule, and wherein the generating the merged configuration file is based on the one or more first resource specific rules and the one or more second resource specific rules.

(M5) A method may be performed as described in any of paragraphs (M1) through (M4) wherein the merged configuration file indicates a default access instruction based on the second default rule, and wherein the generating the merged configuration file is based on the one or more first resource specific rules and the one or more second resource specific rules.

(M6) A method may be performed as described in any of paragraphs (M1) through (M5) further comprising: based on determining that the one or more first resource specific rules overlap with the one or more second resource specific rules, removing, from the merged configuration file, at least one rule that that overlaps with another rule.

(M7) A method may be performed as described in any of paragraphs (M1) through (M6) further comprising: determining, based on the second configuration file of the host network, one or more proxy devices, in the host network, for accessing one or more resources of the host network; determining one or more communication channels between the client device in the client network and the one or more proxy devices; and updating the second configuration file of the host network with one or more identifiers associated with the one or more communication channels.

(M8) A method may be performed as described in any of paragraphs (M1) through (M7) wherein the generating the merged configuration file comprises: based on determining that a proxy device of the one or more proxy devices corresponds to a default rule of the second configuration file of the host network, setting the merged configuration file with a default access instruction based on the default rule.

(M9) A method may be performed as described in any of paragraphs (M1) through (M8) wherein the one or more identifiers associated with the one or more communication channels comprise one or more port numbers of a loopback network interface of the client device.

(M10) A method may be performed as described in any of paragraphs (M1) through (M9) further comprising: configuring the client device with the one or more communication channels via a host device.

(M11) A method may be performed as described in any of paragraphs (M1) through (M10) further comprising: receiving configuration data that indicates that one or more URLs are accessible using the client network or the host network, wherein the generating the merged configuration file is based on the received configuration data.

(M12) A method may be performed as described in any of paragraphs (M1) through (M11) wherein a host device in the host network implements a virtual machine executing a first web browser, and wherein the client device in the client network implements a second web browser, redirected from the first web browser, for executing the merged configuration file.

(M13) A method may be performed as described in any of paragraphs (M1) through (M12) wherein the first configuration file of the client network comprises a proxy auto-config (PAC) file of the client network, and wherein the second configuration file of the host network comprises a PAC file of the host network.

The following paragraphs (A1) through (A4) describe examples of apparatuses that may be implemented in accordance with the present disclosure.

(A1) A computing device comprising: one or more processors; and memory storing instructions that, when executed by the one or more processors, cause the computing device to: receive a plurality of configuration files, the configuration files including a first configuration file of a client network and a second configuration file of a host network, the second configuration file including at least one identifier configured to enable direct access to a resource of the host network; generate a merged configuration file for a client device based on the first configuration file and second configuration file, the merged configuration file is configured to replace the at least one identifier of the second configuration file with an identifier configured to enable the client device to access the resource of the host network via a proxy device; and configure the client device based on the merged configuration file, wherein the configuration of the client device enables an application executable on the client device to access resources of the client network or the host network.

(A2) A computing device may be implemented as described in paragraph (A1) wherein the instructions, when executed by the one or more processors, further cause the computing device to: determine, based on the first configuration file of the client network, one or more first resource specific rules indicating one or more uniform resource locators (URLs) and one or more access methods corresponding to the one or more URLs; and determine, based on the first configuration file of the client network, a first default rule indicating one or more access methods corresponding to URLs other than the one or more URLs.

(A3) A computing device may be implemented as described in any of paragraphs (A1) through (A2) wherein the instructions, when executed by the one or more processors, further cause the computing device to: determine, based on the second configuration file of the host network, one or more proxy devices, in the host network, for accessing one or more resources of the host network; determine one or more communication channels between the client device in the client network and the one or more proxy devices; and update the second configuration file of the host network with one or more identifiers associated with the one or more communication channels.

(A4) A computing device may be implemented as described in any of paragraphs (A1) through (A3) wherein the instructions, when executed by the one or more processors, further cause the computing device to: receive configuration data that indicates that one or more URLs are accessible using the client network or the host network, wherein the generating the merged configuration file is based on the received configuration data.

The following paragraphs (CRM1) through (CRM3) describe examples of computer-readable media that may be implemented in accordance with the present disclosure.

(CRM1) One or more non-transitory computer readable media storing computer readable instructions that, when executed, cause a computing device to: receive a plurality of configuration files, the configuration files including a first configuration file of a client network and a second configuration file of a host network, the second configuration file including at least one identifier configured to enable direct access to a resource of the host network; generate a merged configuration file for a client device based on the first configuration file and second configuration file, the merged configuration file is configured to replace the at least one identifier of the second configuration file with an identifier configured to enable the client device to access the resource of the host network via a proxy device; and configure the client device based on the merged configuration file, wherein the configuration of the client device enables an application executable on the client device to access resources of the client network or the host network.

(CRM2) One or more non-transitory computer readable media may be implemented as described in paragraph (CRM1) wherein the computer readable instructions, when executed, further cause the computing device to: determine, based on the first configuration file of the client network, one or more first resource specific rules indicating one or more uniform resource locators (URLs) and one or more access methods corresponding to the one or more URLs; and determine, based on the first configuration file of the client network, a first default rule indicating one or more access methods corresponding to URLs other than the one or more URLs.

(CRM3) One or more non-transitory computer readable media may be implemented as described in any of paragraphs (CRM1) through (CRM2) wherein the computer readable instructions, when executed, further cause the computing device to: determine, based on the second configuration file of the host network, one or more proxy devices, in the host network, for accessing one or more resources of the host network; determine one or more communication channels between the client device in the client network and the one or more proxy devices; and update the second configuration file of the host network with one or more identifiers associated with the one or more communication channels.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
receiving, by a computing device, a plurality of configuration files, the configuration files including a first configuration file of a client network and a second configuration file of a host network, the second configuration file including at least one identifier configured to enable direct access to a resource of the host network;
generating, by the computing device, a merged configuration file for a client device based on the first configuration file and second configuration file, the merged configuration file is configured to replace the at least one identifier of the second configuration file with an identifier configured to enable the client device to access the resource of the host network via a proxy device; and
configuring, by the computing device, the client device based on the merged configuration file, wherein the configuration of the client device enables an application executable on the client device to access resources of the client network or the host network.

2. The method of claim 1, further comprising:
determining, based on the first configuration file of the client network, one or more first resource specific rules indicating one or more uniform resource locators (URLs) and one or more access methods corresponding to the one or more URLs; and
determining, based on the first configuration file of the client network, a first default rule indicating one or more access methods corresponding to URLs other than the one or more URLs.

3. The method of claim 2, further comprising:
determining, based on the second configuration file of the host network, one or more second resource specific rules associated with the host network; and
determining, based on the second configuration file of the host network, a second default rule, associated with the host network, of the one or more second resource specific rules.

4. The method of claim 3, wherein the merged configuration file indicates a default access instruction based on the first default rule, and wherein the generating the merged configuration file is based on the one or more first resource specific rules and the one or more second resource specific rules.

5. The method of claim 3, wherein the merged configuration file indicates a default access instruction based on the second default rule, and wherein the generating the merged configuration file is based on the one or more first resource specific rules and the one or more second resource specific rules.

6. The method of claim 3, further comprising:
based on determining that the one or more first resource specific rules overlap with the one or more second resource specific rules, removing, from the merged configuration file, at least one rule that that overlaps with another rule.

7. The method of claim 1, further comprising:
determining, based on the second configuration file of the host network, one or more proxy devices, in the host network, for accessing one or more resources of the host network;
determining one or more communication channels between the client device in the client network and the one or more proxy devices; and
updating the second configuration file of the host network with one or more identifiers associated with the one or more communication channels.

8. The method of claim 7, wherein the generating the merged configuration file comprises:
based on determining that a proxy device of the one or more proxy devices corresponds to a default rule of the second configuration file of the host network, setting the merged configuration file with a default access instruction based on the default rule.

9. The method of claim 7, wherein the one or more identifiers associated with the one or more communication channels comprise one or more port numbers of a loopback network interface of the client device.

10. The method of claim 7, further comprising:
configuring the client device with the one or more communication channels via a host device.

11. The method of claim 1, further comprising receiving configuration data that indicates that one or more URLs are accessible using the client network or the host network, wherein the generating the merged configuration file is based on the received configuration data.

12. The method of claim 1, wherein a host device in the host network implements a virtual machine executing a first web browser, and wherein the client device in the client network implements a second web browser, redirected from the first web browser, for executing the merged configuration file.

13. The method of claim 1, wherein the first configuration file of the client network comprises a proxy auto-config (PAC) file of the client network, and wherein the second configuration file of the host network comprises a PAC file of the host network.

14. A computing device comprising:
one or more processors; and
memory storing instructions that, when executed by the one or more processors, cause the computing device to:
receive a plurality of configuration files, the configuration files including a first configuration file of a client network and a second configuration file of a host network, the second configuration file including at least one identifier configured to enable direct access to a resource of the host network;
generate a merged configuration file for a client device based on the first configuration file and second configuration file, the merged configuration file is configured to replace the at least one identifier of the second configuration file with an identifier configured to enable the client device to access the resource of the host network via a proxy device; and
configure the client device based on the merged configuration file, wherein the configuration of the client device enables an application executable on the client device to access resources of the client network or the host network.

15. The computing device of claim 14, wherein the instructions, when executed by the one or more processors, further cause the computing device to:
determine, based on the first configuration file of the client network, one or more first resource specific rules indicating one or more uniform resource locators (URLs) and one or more access methods corresponding to the one or more URLs; and
determine, based on the first configuration file of the client network, a first default rule indicating one or more access methods corresponding to URLs other than the one or more URLs.

16. The computing device of claim 14, wherein the instructions, when executed by the one or more processors, further cause the computing device to:
determine, based on the second configuration file of the host network, one or more proxy devices, in the host network, for accessing one or more resources of the host network;
determine one or more communication channels between the client device in the client network and the one or more proxy devices; and
update the second configuration file of the host network with one or more identifiers associated with the one or more communication channels.

17. The computing device of claim 14, wherein the instructions, when executed by the one or more processors, further cause the computing device to:
receive configuration data that indicates that one or more URLs are accessible using the client network or the host network, wherein the generating the merged configuration file is based on the received configuration data.

18. One or more non-transitory computer readable media storing computer readable instructions that, when executed, cause a computing device to:
receive a plurality of configuration files, the configuration files including a first configuration file of a client network and a second configuration file of a host network, the second configuration file including at least one identifier configured to enable direct access to a resource of the host network;
generate a merged configuration file for a client device based on the first configuration file and second configuration file, the merged configuration file is configured to replace the at least one identifier of the second configuration file with an identifier configured to enable the client device to access the resource of the host network via a proxy device; and
configure the client device based on the merged configuration file, wherein the configuration of the client device enables an application executable on the client device to access resources of the client network or the host network.

19. The one or more non-transitory computer readable media of claim 18, wherein the computer readable instructions, when executed, further cause the computing device to:
determine, based on the first configuration file of the client network, one or more first resource specific rules indicating one or more uniform resource locators (URLs) and one or more access methods corresponding to the one or more URLs; and
determine, based on the first configuration file of the client network, a first default rule indicating one or more access methods corresponding to URLs other than the one or more URLs.

20. The one or more non-transitory computer readable media of claim 18, wherein the computer readable instructions, when executed, further cause the computing device to:
determine, based on the second configuration file of the host network, one or more proxy devices, in the host network, for accessing one or more resources of the host network;
determine one or more communication channels between the client device in the client network and the one or more proxy devices; and
update the second configuration file of the host network with one or more identifiers associated with the one or more communication channels.
